(19) United States
(12) Patent Application Publication
(10) Pub. No.: US 2011/0142181 A1
(43) Pub. Date: Jun. 16, 2011

(54) COMMUNICATION SYSTEM

(76) Inventors: Amir Leshem, Shoham (IL); Jacob Goldberger, Tel-Aviv (IL)

(21) Appl. No.: 12/942,352

(22) Filed: Nov. 9, 2010

Related U.S. Application Data
(60) Provisional application No. 61/272,831, filed on Nov. 9, 2009.
(60) Provisional application No. 61/272,832, filed on Nov. 9, 2009.
(60) Provisional application No. 61/272,834, filed on Nov. 9, 2009.

(51) Int. Cl. H04L 27/06

(52) U.S. Cl. 375/341

(57) ABSTRACT

A communication system having a program of machine-readable instructions for solving an ILS problem, tangibly embodied on a computer readable memory and executable by a digital data processor, to perform actions directed toward outputting a set of a-posteriori probability vectors.

### CROSS-REFERENCE TO RELATED APPLICATIONS

The present application claims priority under 35 U.S.C. §119 to U.S. Provisional Patent Application Nos. 61/272,831 (filed on Nov. 9, 2009), 61/272,832 (filed on Nov. 9, 2009) and 61/272,834 (filed on Nov. 9, 2009), the full contents of each is hereby incorporated by reference in their respective entireties.

### FIELD OF THE INVENTION

The present invention generally relates to communication system, and more specifically to a communication system such as an MIMO system.

### BACKGROUND OF THE INVENTION

Least squares (LS) fitting is one of the most fundamental techniques in science and engineering. It is used to estimate parameters from multiple noisy observations. In many problems the parameters are known a-priori to be bounded integer valued, or they come from a finite set of values on an arbitrary finite lattice. Integer least squares is an important problem also in multichannel communication systems and GPS applications. In this case finding the closest vector becomes NP-Hard problem.

Digital communication using multiple-input-multiple-output (MIMO) (G. J. Foschini, 1996) has recently emerged as one of the most significant technical breakthroughs in modern communications. Given an arbitrary wireless communication system, we consider a link where the transmitting end and the receiving end are equipped with multiple antenna elements.

The idea behind MIMO is that the signals on the transmit antennas at one end and the receive antennas at the other end are combined in such a way that the quality of the communication for each MIMO user will be improved. Such an advantage can be used to increase both the networks quality of service and the operators revenues significantly. The core idea in MIMO systems is space-time signal processing in which time (the natural dimension of digital communication data) is complemented with the spatial dimension inherent in the use of multiple spatially distributed antennas.

Finding the linear least squares fit to data is a well-known problem, with applications in almost every field of science. When there are no restrictions on the variables, the problem has a closed form solution. In many cases, a-priori knowledge on the values of the variables is available. One example is the existence of priors, which leads to Bayesian estimators. Another example of great interest in many applications is when the variables are constrained to a discrete finite set. This problem has many diverse applications such as decoding of multi-input-multi-output (MIMO) digital communication systems, GPS system ambiguity resolution (P. J. G. Teunissen et. al., 2001) and many lattice problems in computer science, such as finding the closest vector in a lattice to a given point in Rn (E. Agrell et. al., 2002), and vector subset sum problems which have applications in cryptography (J. C. Lagarias et. al., 1985). In contrast to the continuous linear least squares problem, this problem is known to be NP hard.

There present known MIMO systems suffer from critical limitations such as the computation time, and the accuracy of the results. Therefore, there is a long felt need to develop a MIMO system with an improved performance by using near-optimal and low complexity algorithms.

### SUMMARY OF THE INVENTION

It is one object of the present invention to provide a communication system having a program of machine-readable instructions for solving an ILS problem, tangibly embodied on a computer readable memory and executable by a digital data processor, to perform actions directed toward outputting a set of a-posteriori probability vectors. The actions include steps of:
a. receiving an input vector x on a plurality of channels;
b. estimating a channel matrix H via a channel tracking unit 240;
c. computing matrices H_{m,n} by a projection generation unit 100;
d. projecting the input vector x onto a low-dimensional subspace via a vector projecting unit 110, the vector projecting unit 110;
e. computing the projections z₁, . . . , z_{d} via a one-dimensional unit 120;
f. computing a prior probability vectors for each coordinate of a solution vector s via a prior probability computation unit 130;
g. calculating the set of a-posteriori probability vectors for each coordinate by performing iterations with low-dimensional computations via a belief propagation unit 140.

It is another object of the present invention to provide a communication system as defined above, whereby the low-dimensional subspace is a two-dimensional subspace.

It is another object of the present invention to provide a communication system as defined above, whereby the final estimated vector is calculated by choosing the maximum a-posteriori probability among all the alphabet symbols.

It is another object of the present invention to provide a communication system as defined above, whereby the prior probability vectors are calculated according to a solution technique selected from the group consisting of: a linear solution, L-MMSE, zero-forcing, V-BLAST, and any combination thereof.

It is another object of the present invention to provide a communication system as defined above, whereby the actions further comprise step of sphere decoding the set of a-posteriori probability vectors.

It is another object of the present invention to provide a communication system as defined above, whereby the actions are performed independently for each tone.

It is another object of the present invention to provide a communication system as defined above, whereby the communication system is a MIMO communication system.

It is another object of the present invention to provide a method for solving an ILS problem in a MIMO communication system having a program of machine-readable instructions, tangibly embodied on a computer readable memory and executable by a digital data processor, including steps of:
a. receiving an input vector x on a plurality of channels;
b. estimating a channel matrix 11 via a channel tracking unit 240;
c. computing matrices H_{m,n} by a projection generation unit 100;
d. projecting the input vector x onto a low-dimensional subspace via a vector projecting unit 110, the vector projecting unit 110;
e. computing the projections z₁, . . . , z_{d} via a one-dimensional unit 120;
f. computing a prior probability vectors for each coordinate of a solution vector s via a prior probability computation unit 130; and,
g. calculating a set of a-posteriori probability vectors for each coordinate by performing iterations with low-dimensional computations via a belief propagation unit 140.

It is another object of the present invention to provide the method as defined above, additionally including a step of providing the low-dimensional subspace in a two-dimensional subspace.

It is another object of the present invention to provide the method as defined above, additionally including a step of calculating the final estimated vector by choosing the maximum a-posteriori probability among all the alphabet symbols.

It is another object of the present invention to provide the method as defined above, additionally including a step of calculating the prior probability vectors according to a solution technique selected from the group consisting of: a linear solution, L-MMSE, zero-forcing, V-BLAST, and any combination thereof.

It is another object of the present invention to provide the method as defined above, additionally including a step of sphere decoding the set of a-posteriori probability vectors.

It is another object of the present invention to provide the method as defined above, additionally including a step of performing the actions independently for each tone.

It is another object of the present invention to provide the method as defined above, additionally including a step of configuring the communication system as a MIMO communication system.

It is another object of the present invention to provide a communication system having a program of machine-readable instructions for solving a detection problem according to a PPBP algorithm, tangibly embodied on a computer readable memory and executable by a digital data processor, to perform actions directed toward outputting a set of a-posteriori probability vectors, the actions including steps of:
a. receiving a tap gain matrix Hₘₓₙ;
b. performing a MMSE linear detection;
c. providing a max-product initialization m_{j->i}(xᵢ)=priorᵢ(xᵢ);
d. calculating the belief propagation for generating probabilities per symbol for each transmitted symbol, thereby providing beliefᵢ(xᵢ) and,
e. calculating the PPBP solution vector xᵢ by choosing the maximum a-posteriori probability among all alphabet symbols according to the equation: xᵢ=argmax_{xi∈A}beliefᵢ(xᵢ).

It is another object of the present invention to provide a communication system as defined above, further adapted to perform at least one action selected from a group consisting of: calculating the MMSE_SIC solution; comparing the performance of the MMSE_SIC solution to the PPBP solution; and selecting the preferred solution from the MMSE_SIC solution and the PPBP solution or any combination thereof.

It is another object of the present invention to provide a communication system as defined above, wherein the actions further including a step of sphere decoding to prune the search according to a-posteriori symbol probabilities.

It is another object of the present invention to provide a communication system as defined above, whereby the actions are performed independently for each tone.

It is another object of the present invention to provide a communication system as defined above, whereby the actions are performed for the calculation of log-likelihood probabilities for each bit.

It is another object of the present invention to provide a communication system as defined above, whereby the communication system is a MIMO communication system.

It is another object of the present invention to provide a method for solving a MIMO detection problem according to a PPBP algorithm in a MIMO communication system having a program of machine-readable instructions, tangibly embodied on a computer readable memory and executable by a digital data processor, including steps of:
a. receiving a tap gain matrix Hₘₓₙ and a measured vector y;
b. performing a MMSE linear detection;
c. providing a max-product initialization m_{j->i}(xᵢ)=priorᵢ(xᵢ);
d. calculating the belief propagation for generating probabilities per symbol for each transmitted symbol, thereby providing beliefᵢ(xᵢ); and,
e. calculating the PPBP solution vector xᵢ by choosing the maximum a-posteriori probability among all alphabet symbols according to the equation: xᵢ=argmax_{xi∈A}beliefᵢ(xᵢ).

It is another object of the present invention to provide the method as defined above, additionally including a step of performing actions selected from a group consisting of: calculating the MMSE_SIC solution; comparing the performance of the MMSE_SIC solution to the PPBP solution; and selecting the preferred solution from the MMSE_SIC solution and the PPBP solution or any combination thereof.

It is another object of the present invention to provide the method as defined above, additionally including a step of sphere decoding to prune the search according to a-posteriori symbol probabilities.

It is another object of the present invention to provide the method as defined above, additionally including a step of performing the actions independently for each tone.

It is another object of the present invention to provide the method as defined above, additionally including a step of performing the actions for the calculation of log-likelihood probabilities for each bit.

It is another object of the present invention to provide the method as defined above, additionally including a step of providing the communication system as a MIMO communication system.

It is another object of the present invention to provide a communication system having a program of machine-readable instructions for solving an ILS problem with a Belief Propagation (BP) paradigm, tangibly embodied on a computer readable memory and executable by a digital data processor, to perform actions directed toward outputting a set of a-posteriori probability vectors, the actions including steps of:
a. receiving a tap gain matrix Hₘₓₙ and a measured vector y;
b. applying a Chow-Liu algorithm on the distribution corresponding to the unconstrained linear system;
c. applying a finite-set constraint and utilizing the Gaussian tree distribution to form a discrete loop free approximation of p(x|y);
d. applying BP on the loop free Markov Random Field (MRF);

It is another object of the present invention to provide a communication system as defined above, wherein the actions further comprise a step of calculating:

$$z = {( {H}^{⊤} H + \frac{{σ}^{2}}{e} I )}^{- 1} {H}^{⊤} y and$$

$$C = {{σ}^{2} ( {H}^{⊤} H + \frac{{σ}^{2}}{e} I )}^{- 1}$$

It is another object of the present invention to provide a communication system as defined above, whereby the step (d) applying BP on the loop free Markov Random Field (MRF) is performed on:

$$\hat{p} ( {x}_{1} , … , {x}_{n} \vert y ) ∝ f ( {x}_{1} ; z , C ) {\prod }_{i = 2}^{n} f ( {x}_{i} \vert {x}_{p ( i )} ; z , C )$$

It is another object of the present invention to provide a communication system as defined above, whereby the communication system is a MIMO communication system.

It is another object of the present invention to provide a method for solving an ILS problem with a Belief Propagation (BP) paradigm in a MIMO communication system having a program of machine-readable instructions, tangibly embodied on a computer readable memory and executable by a digital data processor, including steps of:
a. receiving a tap gain matrix Hₘₓₙ and a measured vector y;
b. applying a Chow-Liu algorithm on the distribution corresponding to the unconstrained linear system;
c. applying a finite-set constraint and utilizing the Gaussian tree distribution to form a discrete loop free approximation of p(x|y);
d. applying BP on the loop free Markov Random Field (MRF);

It is another object of the present invention to provide the method as defined above, additionally including a step of calculating the actions according to formula:

$$z = {( {H}^{⊤} H + \frac{{σ}^{2}}{e} I )}^{- 1} {H}^{⊤} y and$$

$$C = {{σ}^{2} ( {H}^{⊤} H + \frac{{σ}^{2}}{e} I )}^{- 1}$$

It is another object of the present invention to provide the method as defined above, whereby the step (d) applying BP on the loop free Markov Random Field (MRF) is performed on:

$$\hat{p} ( {x}_{1} , … , {x}_{n} \vert y ) ∝ f ( {x}_{1} ; z , C ) {\prod }_{i = 2}^{n} f ( {x}_{i} \vert {x}_{p ( i )} ; z , C )$$

It is lastly an object of the present invention to provide the method as defined above, additionally including a step of providing the communication system as a MIMO communication system.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIGS. 1a-b are schematic illustration an integer ILS solving unit in accordance with an embodiment of the present invention.

FIG. 2 is a schematic illustration of 5 subunits of the ILS solving unit in accordance with embodiments of the present invention.

FIG. 3 is a schematic illustration of one implementation of a communication receiver for multiple-input-multiple-output communication system.

FIGS. 4a-b are illustrations of symbol error rate results in accordance with an embodiment of the present invention.

FIG. 5 illustrates SER results in accordance with an embodiment of the present invention.

FIG. 6 is an illustration of experimental result of over 500 channel realizations.

FIG. 7 is a pseudo code of the algorithm in accordance with embodiments of the present invention.

FIG. 8 is a summary of a Pseudo-Prior-Belief-Propagation (PPBP) algorithm in accordance with embodiments of the present invention.

FIGS. 9a-b are experimental results of a symbol error rate (SER) versus SNR for a 8×8 BPSK MIMO system.

FIGS. 10a-b are improved performance results of the PPBP in accordance with embodiments of the present invention.

FIG. 11 is an example of a MIMO real-valued system based on an 8×8 matrix and A={−1, 1}.

FIG. 12 is a summary of the GTA algorithm in accordance with embodiments of the present invention.

FIG. 13 are experimental results of a symbol error rate (SER) versus SNR, in accordance with embodiments of the present invention.

FIG. 14 are comparative results of MMSE, MMSE-SIC and the GTA approximation, in accordance with embodiments of the present invention.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The term ‘MIMO’ refers hereinafter to any known in the art multiple-input-multiple-output communication system. The term ‘ILS’ refers hereinafter to Integer least squares solution technique. The term ‘PPBP’ refers hereinafter to Pseudo-Prior-Belief-Propagation algorithm disclosed below. The term ‘BP’ refers hereinafter to a Belief-Propagation algorithm.

It is one object of the present invention to provide a polynomial time algorithm that not only solves the ILS problem, but also is capable to provide the a-posteriori probability distribution for each element in the solution vector. It is another object of the present invention to provide simulated experiments comparing the algorithm to other sub-optimal algorithms.

Herein a system implementing a new ILS solver is disclosed. This section also discloses a receiver for a MIMO system utilizing the ILS to decode the received data in a computationally efficient manner.

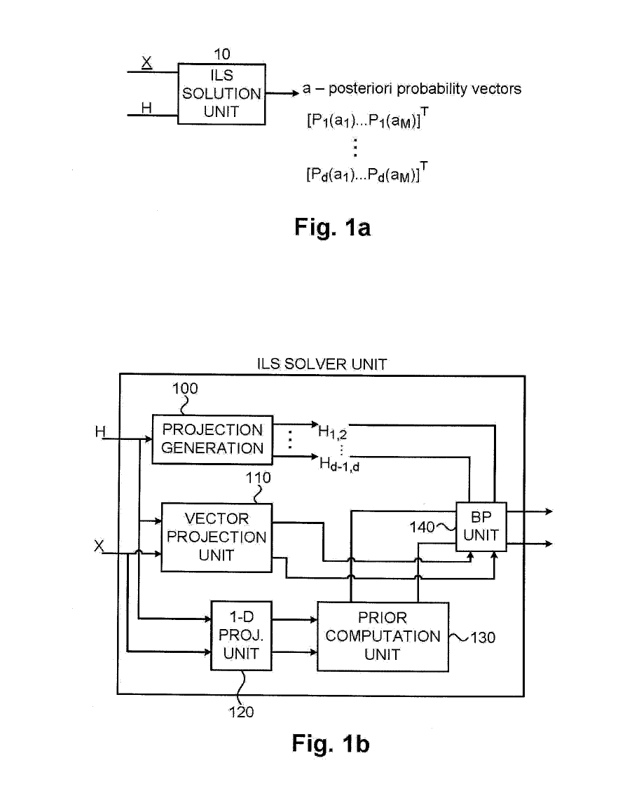

Reference is now made to FIG. 1 which schematically illustrates an integer ILS solving unit 10 in accordance with an embodiment of the present invention. According to this figure, the ILS solving unit 10 has two inputs: a vector x of size p and a p×d matrix H. The output is a set of a-posteriori probability vectors p₁, . . . , p_{d} as defined in (9). ILS solving unit 10 is composed of 5 subunits:
1. A projection generation matrix 100, that computes the matrices H_{m,n.}
2. A vector projection unit 110 that projects the input vector x onto the two-dimensional subspaces.
3. A one-dimensional projection unit 120 computes the projections, required for computing the priors.
4. A prior probability computation unit 130 that computes the prior probabilities for each coordinate of the solution vector s.
5. A belief propagation unit 140 that iterates the two-dimensional computations starting with the prior dis-tribution, to obtain the posterior probability distribution for each coordinate.

In accordance with embodiments of the present invention, the present invention discloses a communication system having a program of machine-readable instructions for solving an ILS problem, tangibly embodied on a computer readable memory and executable by a digital data processor, to perform actions directed toward outputting a set of a-posteriori probability vectors. The actions include steps of:
a. receiving an input vector x on a plurality of channels;
b. estimating a channel matrix H via a channel tracking unit 240;
c. computing matrices H_{m,n} by a projection generation unit 100;
d. projecting said input vector x onto a low-dimensional subspace via a vector projecting unit 110;
e. computing the projections z₁, . . . , z_{d} via a one-dimensional unit 120;
f. computing a prior probability vectors for each coordinate of a solution vector s via a prior probability computation unit 130;
g. calculating the set of a-posteriori probability vectors for each coordinate by performing iterations with low-dimensional computations via a belief propagation unit 140.

In accordance with embodiments of the present invention, the communication system is a MIMO communication system.

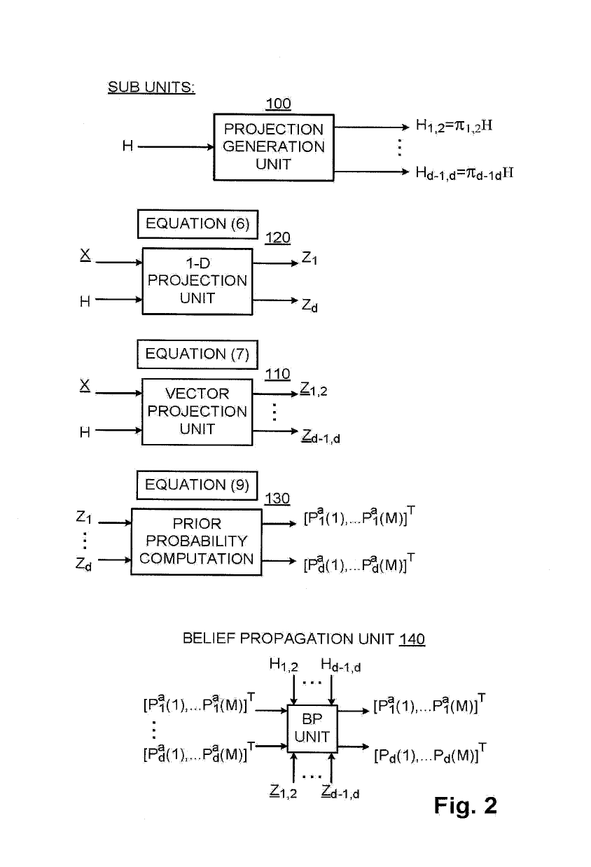

Reference is now made to FIG. 2 which schematically illustrates the 5 subunits of ILS solving unit 10. Each of the subunits illustrated in this figure is adapted to receive an input data, and to output a calculation result according to equations (6)-(13).

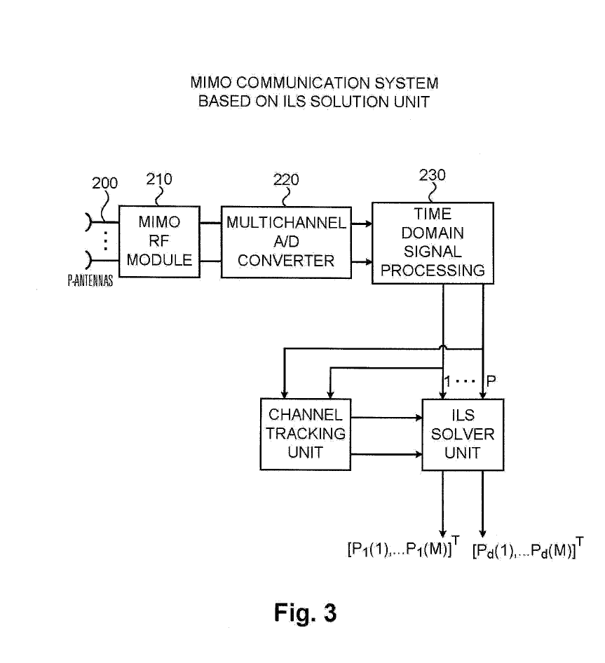

Reference is now made to FIG. 3 which schematically illustrates an implementation of a communication receiver for multiple-input-multiple-output communication system. The receiver in this figure outperforms all simple receivers, and operates very close to the Maximum likelihood receiver, which is computationally infeasible for large number of spatial streams and high order modulations such as 16 and 64-QAM. In contrast to sphere decoding techniques, the proposed algorithm also has ensured polynomial complexity. The system of FIG. 3 is composed of multiple antennas 200, each followed by its own RF chain 210 that down-samples the signal to basedband or low IF. The down-sampled signals are sampled using the multichannel Analog to Digital Conversion unit 220. The baseband signal is passed through a time domain signal processing unit 230 which performs time, frequency and phase noise corrections, interpolation. These samples are then fed into a channel tracking unit 240 that estimates the channel matrix H, and into an ILS solver 250 of the present invention. The probability distribution provided by the ILS solver is converted into log-likelihood ratios per bit, and fed into the digital back-end unit 260, performing de-interleaving and decoding of the Forward Error Correction. The error correction code can be for example, a convolution code, a turbo code or an LDPC code.

The problem of finding least squares fit to data is a well known problem, with applications in almost every field of science. When there are no restrictions on the variables the problem has a closed form solution (S. M. Kay. Fundumentals of statistical signal processing: Estimation theory, PTR, Prentice Hall, 1993). In many cases a-priori knowledge on the value of the variables is known. One examples is the existence of priors, which leads to Bayesian estimators. Another example that is of great interest in many applications is when the variables are constrained to be either integer or constrained to a discrete finite set. This problem has many diverse applications such as decoding of multi-input-multi-output (MIMO) digital communication systems, GPS system ambiguity resolution (P. J. G. Teunissen, Success probability of integer gps ambiguity rounding and bootstrapping, Journal of Geodesy, 72:606-612, October 1998), radar interferometry (Bert M. Kampes. Radar interferometry. Springer, 2006) and many lattice problems in computer science, such as finding the closest vector in a lattice to a given point in RN (E. Agrell et al., Closest point search in lattices, IEEE Transactions on Information Theory, 48(8):2201-2214, August 2002), and vector subset sum problems which have applications to cryptography (J. C. Lagarias and A. M. Odlyzko, Solving low-density subset sum problems, J. ACM, 32(1):229-246, 1985).

In contrast to the unconstrained LS, this problem is known to be NP-HARD (P. van Emde Boas, Another NP-complete partition problem and the complexity of computing short vectors in a lattice, Technical Report Dept. of Mathematics, Univ. of Amsterdam 81-04, 1981). Furthermore, even finding good approximations is an NP-HARD problem. Since the problem is computationally hard, many solutions have been proposed during the years. These solutions, vary from simple linear inversion known as Babai estimator (L Babai et al., On Lovasz' lattice reduction and the nearest lattice point problem, Combinatorica, 6(1):1-13, 1986), combination of linear reduction and sequential decoding (G. J. Foschini, Layered space-time architecture for wireless communication in a fading environment when using multi-element antennas, Bell Labs Technical Journal, 1(2):41-59, 1996), to clever search techniques over the tree of possible solutions, known as sphere decoding (Michael Pohst, On the computation of lattice vectors of minimal length, successive minima and reduced bases with applications, SIGSAM Bull., 15(1):37-44, 1981), (C. P. Schnorr and M. Euchner, Lattice basis reduction: Improved practical algorithms and solving subset sum problems, Journal of Mathematical Programming, 66(1-3):181-199, August 1994).

The earlier solutions suffer from significant loss due to noise amplification and work poorly on ill-conditioned matrices, while the latter have exponential average complexity (J. Jalden and B. Ottersten. On the complexity of sphere decoding in digital communications, IEEE Transactions on Signal Processing, 53(4):1474-1484, April 2005). A good overview of sphere decoding and lattice reduction techniques is given in (E. Agrell et. al., 2002).

The problem of decoding of linear error correcting codes where maximum-likelihood decoding is infeasible, and one needs to design special families of codes such as turbo codes (C. Berrou et al., Near shannon limit error-correcting coding and decoding: Turbo-codes, 1. IEEE International Conference on Communications, 1993. ICC 93. Geneva. Technical Program, Conference Record, 2:1064-1070 vol. 2, 23-26 May 1993) or low density parity check codes (LDPC) (R. Gallager, Low-density parity-check codes, IEEE Transactions on Information Theory, 8(1):21-28, January 1962), that are amenable to simplified decoding techniques. The simplifying idea behind all these codes is the notion of iterative decoding. These codes can be represented by simple graphs, and probability distributions of the variables are updated by adjacent nodes, using a message passing and probability update, known as belief propagation.

In Shental et. al., A message passing solver for linear systems, Information Theory and Applications (ITA) Workshop, pp. 225-229, 2008) it is proposed to solve Gaussian elimination using belief propagation. However, in the solution proposed by Shental et al., the variables were continuous and the equations were noiseless. This led to reduction of the complexity of solving Gaussian equations which is initially O(N3). A related work (O. Shental et al., Generalized belief propagation receiver for near-optimal detection of two-dimensional channels with memory, IEEE Information Theory Workshop, 2004., pages 225-229, 24-29 Oct. 2004) assumed structured 2-D interference matrix (2-D Wyner type of model (S. Shamai and A. D. Wyner, Information-theoretic considerations for symmetric, cellular, multiple-access fading channels, i. IEEE Transactions on Information Theory, 43(6):1877-1894, November 1997), where the interference matrix is banded) and used generalized belief propagation to perform multi-user detection. A significantly limiting assumption in their technique is that the channel matrix is banded, so that only neighboring symbols affect any given signal. Otherwise, the complexity of their approach grows exponentially.

In accordance with embodiments of the present invention, belief propagation techniques are implemented to provide improved suboptimal solutions to the general integer least squares problem. As part of the algorithm, the main problem is divided into a large set of partially overlapping sub-problems, where each subproblem can be solved optimally. Each of the solvers of the sub-problems provides information to the other solvers through the process of belief propagation. The process is iterated until converge of all the a-posteriori probability distributions for each of the variables is achieved. The solution is then obtained by assigning to each of the variables the symbol that maximizes its a-posteriori probability. The solution allows us to provide a-posteriori probability distributions to each bit of each variable, something desirable in coded communication systems. Such probabilities are hard to evaluate using sphere decoding types of solution.

The major advantage of the approach of the present invention over that of O. Shental et. al. is that the present invention alleviates the requirement for banded channel matrix. This is done by using a large family of carefully selected low dimensional projections. Furthermore, all projections are used onto low-dimensional subspaces of the channel matrix. This implies that the pre-processing, introduces redundant equations. It is the information in these equations, that allows the very good performance of the proposed method. The proposed method is also demonstrated through simulations, where it is compared to several sub-optimal solutions as well as the maximum likelihood solution (when the alphabet size is 2 or 4).

PROBLEM FORMULATION: Let H∈ [symbol] be a known (to the receiver) matrix (we assume here that [symbol] = [symbol] . Assume that the unknown vector s ∈ [symbol] where d is the number of columns of H and [symbol] ⊂ [symbol] is a finite set. Let M=| [symbol] | be the alphabet size and let [symbol] ={α₁ . . . , α_{M}} be the symbols of [symbol] . The measured signal is given by

x=Hs+n (1)

where n˜CN(0, φ²I) is a white Gaussian noise vector with known variance. The algorithm has to recover s from x. The well known Maximum likelihood estimator in this case is given by

$$s = arg {max}_{S ∈ {𝔸}^{d}} {‖ x - Hs ‖}^{2} \qquad ( 2 )$$

While the maximum likelihood estimator has very good performance, its complexity grows exponentially with d and is O(M^{d}pd²). For large M the first term is dominant.

Similarly when the noise covariance is a known matrix C we can whiten the noise and the ML estimator becomes:

$$s = arg {max}_{S ∈ {𝔸}^{d}} {( x - Hs )}^{*} {C}^{- 1} ( x - Hs ) \qquad ( 3 )$$

Pre-multiplying the measurement vector by R⁻¹ where c=RR* is the Choleski decomposition of C yields the problem (2) again.

A second related problem is the Bayesian version, where given an a-priori distribution on the components of the solution, we would like to find the a-posteriori distribution of the vectors, given the measurement vector x. This problem appears naturally in the decoding of coded multiple antenna systems, where a first step termed the channel decoding amounts to computing a-posteriori probabilities and log-likelihood ratio for each transmitted bit.

The problem (2) is also related to the closest vector problem, where given vectors h₁, . . . , h_{d} we would like to find integers s₁, . . . , s_{d} such that Σₙ^{d}=1 hᵢsᵢ is closest to the vector x.

OVERVIEW OF SUB-OPTIMAL TECHNIQUES: There are many suboptimal solutions to the problem of E. Agrell et. al. Many of these are based on sphere decoding by pruning the tree of possible coefficients. This solution has complexity that is exponential in d (J. Jalden et. al., 2005) and therefore hard to implement for large problems. Especially if the alphabet size is large, as in typical MIMO systems where constellation size of 64 is common. However, these solutions while providing the closest point do not easily provide likelihood ratios per symbol or per bit a-posteriori probabilities. Reduced complexity solutions include semidefinite relaxation (A. Wiesel et al., Semidefinite relaxation for detection of 16-QAM signaling in MIMO channels, IEEE Signal Processing Letters, 2005) and (N. D. Sidiropoulos and Z.-Q. Luo, A semidefinite relaxation approach to MIMO detection for high-order QAM constellations, IEEE Signal Processing Letters, 13(9):525-528, September 2006. Since these algorithms find the closest point in the lattice by relaxed optimization, it is much harder to compute a-posteriori probabilities per symbol or per bit, which is required, when error correction is used (e.g., in communication applications). On the lower complexity side we find linear techniques, by premultiplying the data vector with a matrix W and then finding the closest point in each coordinate independently. When W is the pseudo inverse of H this is known as a zero-forcing solution or Babai estimator (L Babai, 1986). A better alternative is using the linear minimum mean square error estimator (L-MMSE) where

W=H*(HH*+φ²I)⁻¹.

A large improvement over the linear receivers is given by using what is known as sequential interference cancelation in the communication literature. The vector x is multiplied by a vector w₁ and s₁ is estimated by finding the closest Ŝ₁. x is replaced by x−h₁Ŝ₁ and the process is repeated. The algorithm is called ZF-V-BLAST or MMSE V-BLAST (G. J. Foschini, 1996), and is also known as SIC. The complexity of this algorithm is on the order of O(d³). With these algorithms it is also easy to provide probability estimates for each symbol or each bit.

BELIEF PROPAGATION FOR SOLVING INTEGER LEAST SQUARES PROBLEMS: In accordance with one object of the present invention, a novel polynomial time algorithm for solving the bounded integer least squares problem is presented. The algorithm outperforms other reduced complexity algorithms with lower complexity. We begin with some notation. In order to define our decoder we need the following:

1. Let h₁, . . . , h_{d} be the columns of H=[h₁, . . . , h_{d}] and assume that H has a full column rank.

2. Let V_{m,n} be the subspace

V_{m,n}=Span{hₖ:k∉{m,n}} (4)

3. Let ┌_{m,n}:C→V_{m,n}^{⊥} be the projection onto the orthogonal complement of V_{m,n.}

4. More generally for each subset i ⊂{1, . . . , d} Let

Vᵢ=Span{hₖ:k∉i}

and let Πᵢ: C→Vᵢ^{⊥} be the projection onto the orthogonal complement of Vᵢ. When i={m} we use we use Vₘ, Πₘ, and when i={m,n} we use V_{m,n}, Π_{m,n.}

Note that Πₘ is the projection onto hₘ so that

zₘ=Πₘx=αₘhₘsₘ+νₘ (6)

where νₘ is the Gaussian noise projected onto hₘ,

$${\hat{s}}_{m} = \frac{{h}_{m}^{*} {\prod }_{m}^{ } x}{{‖ {h}_{m} ‖}^{2}}$$

is the ZF estimate of Sₘ. In order to obtain our decoder we define a 2-dimensional MIMO ZF decoder. For each m≠n Let

z_{m,n}=Π_{m,n}x=H_{m,n}s_{m,n}+ν_{m,n} (7)

where

H_{m,n}=[α_{m,n}hₘ,β_{m,n}hₙ]

s_{m,n}=[sₘ,sₙ]^{T}

ν_{m,n}=Π_{m,n}ν (8)

By linearity for all m≠n, the vectors ν_{m,n} are Gaussian with zero mean and variance φ_{m,n}²

Note that by its definition Π_{m,n} cancels all signals except m,n the signals. Performing this operation for all pairs m≠n we obtain (₂^{d}) sparse equations, where each equation depends on 2 variables.

Assume that for each m=1, . . . , d we have an a-priori probability distribution on sₘ i.e., probability vectors pₘ(pₘ(i): αᵢ∈A), where pₘ(i)=P(sₘ=αᵢ). Given z_{m,n} we can compute the a-posteriori probability for sₘ, sₙ by

$${p}_{m}^{a} ( l ) = \frac{{p}_{m} ( l ) {\sum }_{k = 1}^{M} {p}_{n} ( k ) {D}_{m , n} ( l , k )}{{\sum }_{i = 1}^{M} {\sum }_{k = 1}^{M} {p}_{m} ( i ) {p}_{n} ( k ) {D}_{m , n} ( i , k )} \\ {p}_{n}^{a} ( l ) = \frac{{p}_{n} ( l ) {\sum }_{k = 1}^{M} {p}_{m} ( k ) {D}_{m , n} ( k , l )}{{\sum }_{i = 1}^{M} {\sum }_{k = 1}^{M} {p}_{m} ( i ) {p}_{n} ( k ) {D}_{m , n} ( k , i )} \qquad ( 9 )$$

where a_{i,k}=[αᵢ, αₖ]^{T} are the two-dimensional constellation vectors and
compute the a-posteriori probability for sₘ, sₙ by

$${D}_{m , n} ( l , k ) {e}^{- \frac{1}{{σ}_{m , n}^{2}} {‖ {z}_{m , n} - {H}_{m , n} {a}_{l , k} ‖}^{2}} \qquad ( 10 )$$

The set of equations (7) for all m≠n generates a (d:(₂^{d})) bi-partite graph: which is (d−1,2) regular. The d variable nodes contain the probability distribution pₘ, each connected to d−1 equation nodes e_{m,n} containing z_{m,n.}

We can now use belief propagation to update the a-posteriori probabilities [symbol] pₘ: m=1, . . . , d [symbol] . The a-priori probabilities for each variables are generated using the ZF projection matrices Πₘ, m=1, . . . , d. The a-priori probability for each variable sₘ, m=1, . . . , d using the one-dimensional ZF projection is given by:

$${p}_{m} ( l ) = \frac{{e}^{- \frac{1}{{σ}_{m}^{2}} {‖ {z}_{m} - {h}_{m} {a}_{l} ‖}^{2}}}{{\sum }_{k = 1}^{M} {p}_{m} ( k ) {e}^{- \frac{1}{2 {σ}_{m}^{2}} {‖ {z}_{m} - {α}_{m} {h}_{m} {a}_{k} ‖}^{2}}} \qquad ( 11 )$$

The algorithm: To decode an integer LS problem we the following steps are performed: First of all, all the matrices H_{m,n} are calculated. This amount to [symbol] QR factorizations for each m≠n. This has complexity O(d²p³), but it is done once in the beginning of the decoding process.

Now for each received vector x we first use a ZF receiver to generate the a-priori probability distributions pₘ; m=1, . . . , d, using (11). This has complexity of O(p³) since the main problem is the computation of the ZF receiver. Computing the priors is O(Md). The next step is to compute for each two-dimensional vector of constellation points the metric

$${D}_{m , n} ( 𝓁 , k ) = {e}^{- \frac{1}{{σ}_{m , n}^{2}}} {‖ {z}_{m , n} - {H}_{m , n} {a}_{𝓁 , k} ‖}^{2} \qquad ( 12 )$$

where a_{l,k}=[αₗ αₖ]^{T} are the two-dimensional constellation vectors. This has complexity of O(d²M²). This is done once for each received vector.

Now we go over all vectors z_{m,n} sequentially and update pₘ, pₙ using (9). This is done until convergence is achieved, typically with few iterations. The overall complexity is O(M²Nᵢₜₑᵣ)

After convergence the solution is given by choosing for each m=1, . . . , d

$${s}_{m} = arg {max}_{{a}_{l} ∈ 𝔸} {p}_{m} ( l ) \qquad ( 13 )$$

This algorithm maximizes the function:

$${\prod }_{ } {e}^{- \frac{{‖ {z}_{m , n} - {H}_{m , n} {s}_{m , n} ‖}^{2}}{{σ}_{m , n}^{2}}} . \qquad ( 14 )$$

Since the projections are not orthogonal (we have more projections than the dimension of the space) the algorithm is still sub-optimal. However, it outperforms all other polynomial sub-optimal algorithms.

B. Performance complexity trade-offs: The algorithm disclosed above (in section V) is based only on two-dimensional subspaces. It is straightforward to improve the algorithm by using projections on higher dimensional subspace. The complexity increases. It is also not necessary to use all the (₂^{d}) 2-D subspaces. This can be reduced. A simplified approach where only d subspaces are used can be used by bi-diagonalizing the channel matrix. The loss however, is significant.

VI. SIMULATIONS: The present invention also discloses several simulated experiments, testing the performance of the proposed algorithm, compared to other suboptimal algorithms such as the V-BLAST and the linear ZF solution (Babai estimator). The solution of the present invention's algorithm can also be compared to the optimal linear MMSE solution and to the maximum likelihood estimator. From this comparison it reveals that although the algorithm of the present invention is significantly better than other suboptimal solutions, it still does not achieve the ML performance.

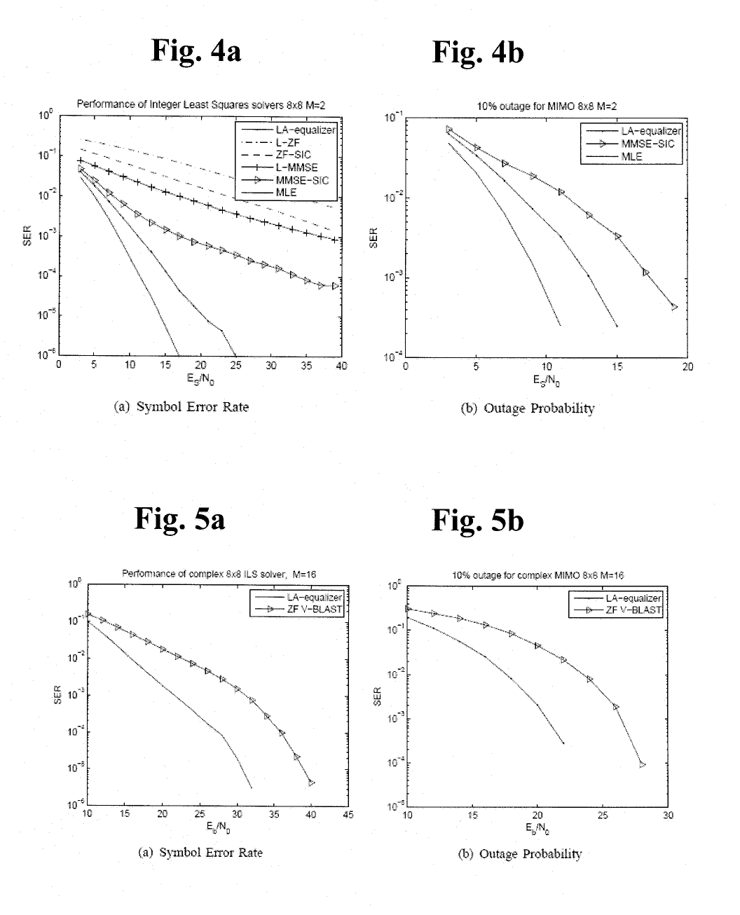

In the first experiment the algorithm on 8×8 systems was tested, where the solution vector was composed of −1,1 elements (M=2). 500 real Gaussian were picked, random 8×8 matrices. For each matrix, 2000 realizations of the problem were solved for each level of the Gaussian noise. Altogether 10⁶ 8×8 systems were solved per value of the noise. The Gaussian noise variance may change from 6 dB to 40 dB. The symbol error rate results are shown in FIG. 4a. We can clearly see that the Linear A-posteriori estimator (LA-equalizer) of the present invention is about 3 dB away from the ML at symbol error rate of 10⁻³, while the other suboptimal techniques can be 8dB away from the maximum likelihood estimator. FIG. 4b depicts the 10% outage results, i.e., the SER achieved by 90% of the channels. For low outage, the results are even more significant. The data of FIGS. 4a-b is calculated according to 8 variables, M=2 and 500 Random Gaussian matrices.

The experiments with 8×8 complex matrices were repeated, while M=16. The SER results are shown in FIG. 5a and the 10% outage results are depicted in FIG. 3b. As in the real case we can see here that the performance of the new estimator is much better than the simplified classical estimators. In this case we have not computed the ML estimator since it would require 2³² 8×8 complex matrix multiplications per iteration per value of the noise variance. The data of FIGS. 5a-b is calculated according to 8 variables, M=16 and 500 Random Gaussian matrices.

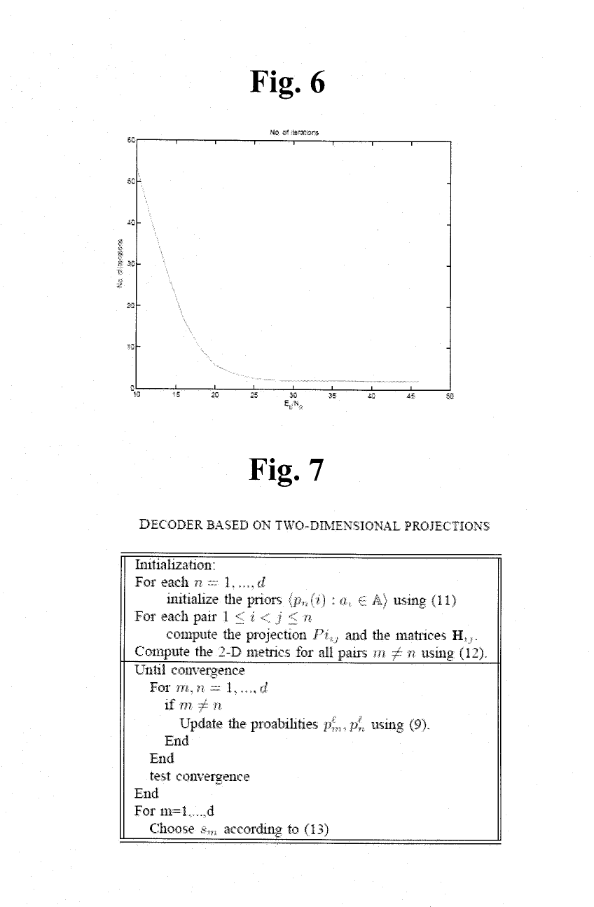

Finally, the number of iterations until convergence have been checked. For a given channel and a given noise variance, the maximal number (over all noise realizations) was calculated until probability distribution change for all symbols was less then 0.01. FIG. 6 depicts the average of this number over 500 channel realizations. The number of iterations was about 50 for the low signal to noise ratio, but converged quickly to about 2 when the signal to noise ratio was higher. The data of FIG. 6 is calculated according to 8 variables, M=16 and 500 Random Gaussian matrices.

FIG. 7 presents the pseudo code of the algorithm in accordance with embodiments of the present invention.

Extensions of the method: A. Combination with sphere decoding: While the method provides an excellent performance, it is interesting to mention that the fact that the method provides a-posteriori probabilities for each variable, applying a Schnorr-Euchner sphere decoding (C. P. Schnorr, 1994), ordering the symbols according to their a-posteriori probabilities can lead to very close to optimal performance in a significantly reduced complexity. The reason for that is that by computing the a-posteriori probabilities, we have much higher probability of finding the true solution within during the first search, therefore significantly reducing the search radius.

Applications: In this section several important applications of the present invention are reviewed. We comment on combining it into communication systems with coding and interleaving. It is useful both for single carrier and OFDM systems. The algorithm described in this paper can be used to solve integer list squares problems. It can serve as a MIMO decoder for wireless communication systems. Using the a-posteriori probability distribution of the symbols the a-posteriori probability and the likelihood ratio for the bits can be easily calculated. This is done using the following formulas:

$$P ( {b}_{i} = 0 ) = \frac{{\sum }_{s \text{:} {b}_{i} = 0}^{ } P ( S \vert X )}{{\sum }_{s}^{ } P ( S \vert X )} \\ P ( {b}_{i} = 1 ) = \frac{{\sum }_{tS \text{:} {b}_{i} = 1}^{ } P ( S \vert X )}{{\sum }_{s}^{ } P ( S \vert X )} \qquad ( 15 )$$

Using equation (15) we can pass to a forward error correction block log-likelihood ratios given by

$$L ( {b}_{i} ) = log \frac{{\sum }_{s \text{:} {b}_{i} = 0}^{ } P ( s \vert x )}{{\sum }_{s \text{:} {b}_{i} = 1}^{ } P ( s \vert x )} \qquad ( 16 )$$

Similarly one can simply compute the max-log-map ration given by

$${L}_{max} ( {b}_{i} ) = log \frac{{max}_{s \text{:} {b}_{i} = 0} P ( s \vert x )}{{max}_{s \text{:} {b}_{i} = 1} P ( s \vert x )} \qquad ( 17 )$$

Note however that this is not so significant simplification in our case, since we first compute the a-posteriori distribution of symbols. The techniques can be combined into MIMO-OFDM system with bit interleaved coded modulation or with trellis coded modulation by joint coding of over all frequency tones of the OFDM system, and running the ILS decoder for each tone. For single carrier systems the channel matrix can be a Toeplitz matrix. This has no effect on the applicability of the technique. We still project the data vectors onto the low-dimensional subspaces. This is equivalent to using multiple partial-response equalizers. Using all the equalizers allows much better performance in terms of computing the log-likelihood ratios, required.

An additional application of the present invention may be to multi-cell cellular systems. Using the integer least squares decoder, multi-cell equalization may be performed, so that other cell interference is completely removed. This is done by performing multi-user detection, using the algorithm, and the channel matrices between all the users and all the base stations of interest.

A possible extension of the method of the present invention is by feeding back the bit probabilities after re-encoding, into the channel tracking and the ILS solver, as new prior probabilities, and re-iterating the ILS solution.

In accordance with embodiments of the present invention, the present invention discloses a new MIMO detection algorithm: the Pseudo-Prior-Belief-Propagation (PPBP). This algorithm can achieve near maximum likelihood (ML) performance with low computational complexity for BPSK and 4-QAM constellations.

In accordance with certain embodiments, the first step of this algorithm a minimum mean square error (MMSE) detection is implemented to yield a pseudo-prior information on each symbol. In the following step, this information is combined into a loopy Belief-Propagation (BP) algorithm as a pseudo-prior. Unlike current paradigm, the Belief-Propagation (BP) algorithm can be advantageous even for very loopy graphs with many short loops. The performance of the proposed algorithm is demonstrated based on extensive simulation results for a variety of scenarios.

MIMO systems can be modeled in a compact and elegant way as a linear system with additive Gaussian noise where the unknown variables are taken from a finite predefined set. The MIMO detection problem is then translated into solving a constrained linear system to receive the transmitted information. The graphical model induced by the detection problem is very loopy with many short loops. It is actually a complete graph where each variable is connected to all the other variables, making it the loopiest a graph can get. Previous attempts to apply loopy Belief-Propagation (BP) algorithms to this problem have all yielded poor results.

In accordance with embodiments of the present invention, a modified BP algorithm is provided. This algorithm is based on pseudo prior information that is computed in a pre-processing step. This algorithm, which is called Pseudo-Prior-Belief-Propagation (PPBP), makes the BP approach feasible for MIMO detection and results in a near-optimal and low complexity algorithm. Below are provided: a formal definition of the MIMO detection problem with a review of previous algorithms; a proposed algorithm in accordance with embodiments of the present invention; and, extensive experimental results of the algorithm.

The MIMO detection problem: A multiple-input-multiple-output (MIMO) is a communication system with n transmit antennas and m receive antennas. The tap gain from transmit antenna i to receive antenna j is denoted by Hᵢⱼ. In each use of the MIMO channel a signal vector x=(x₁, . . . , xₙ)^{τ} is independently selected from a set of constellation points A according to the data to be transmitted, so that x ∈Aⁿ. The received vector y is given by:

y=Hx+∈ (1)

The vector ∈ is an additive noise in which the noise components are assumed as zero mean, statistically independent Gaussians with a known variance φ². The channel matrix which is assumed to be known, comprises iid elements drawn from a (circularly symmetric zero-mean complex) normal distribution of unit variance. In the case where the MIMO linear system is complex-valued we use the standard method to translate it into an equivalent double-size real-valued representation that is obtained by considering the real and imaginary parts separately:

$$[ \begin{matrix}Re ( y ) \\ Im ( y )\end{matrix} ] = [ \begin{matrix}Re ( H ) & - Im ( H ) \\ Im ( H ) & Re ( H )\end{matrix} ] [ \begin{matrix}Re ( x ) \\ Im ( x )\end{matrix} ] + [ \begin{matrix}Re ( ε ) \\ Im ( ε )\end{matrix} ]$$

The MIMO detection problem is then becomes finding the transmitted vector x given H and y. The optimal maximum likelihood (ML) solution is:

$$\hat{x} = arg {min}_{x ∈ {A}^{n}} {‖ Hx - y ‖}^{2} \qquad ( 2 )$$

However, ML decoding has exponential computational complexity which makes it unfeasible when either the number of transmitted antennas or the constellation size are large. Actually, for a general H, it is known to be exponentially complex both in the worst-case sense (M. Grotschel et al., Geometric algorithms and combinatorial optimization, Springer Verlag, 2nd edition, 1993) as well as in the average sense (M. Ajtai, The shortest vector problem in L2 is NP-hard for randomized reductions, Proceedings of the 30th Annual ACM Symposium on Theory of Computing, pages 10-19, 1998). It can be easily verified that the MIMO ML detection problem is equivalent to a least square lattice search problem that is known to be NP hard. A simple approximation is the zero-forcing (ZF) algorithm which is based on a linear decision ignoring the finite constellation constraint:

\hat{x}=(H^{τ}H)⁻¹H^{τ}_{y} (3)

and then, neglecting the correlation between the symbols, finding the closest constellation point for each symbol independently. This scheme performs poorly due to its inability to handle ill-conditioned channel matrix realizations. Somewhat better performance can be obtained by using a minimum mean square error (MMSE) filter instead of ZF on the un-constrained linear system:

\hat{x}=(H^{τ}+φ²I)⁻¹H^{τ}_{y} (4) (4)

and then finding the closest lattice point in each component independently. A vast improvement over the linear approach can be achieved by using sequential ZF decoding. The ZF-V-BLAST detection algorithm (P. W. Wolniansky et al., V-BLAST: An architecture for realizing very high data rates over the rich-scattering wireless channel. Proc. ISSE Conf., 1998.) is based on the linear zero-forcing solution, but detects the signals one after another and not in parallel. The best performance can be achieved by always choosing the layer with the largest post detection signal-to-noise-ratio (SNR), or equivalently with the smallest estimation error. The adaptation to the MMSE criterion was presented in (B. Hassibi, An efficient square-root algorithm for BLAST, IEEE Intl. Conf. Acoustic, Speech, Signal Processing, pp. 5-9, 2000) where the optimal sequence maximizes the signal-to-interference-and-noise ratio (SINR) in each detection step. This algorithm, known as MMSE V-BLAST or MMSE-SIC, has the best performance for this family of linear-based algorithms. However, there is a still a significant gap between the detection performance of the MMSE-SIC algorithm and the performance of the optimal ML detector. The complexity of all these algorithms is O(n³) where n is the number of transmit antennas. These algorithms can also easily provide probabilistic (soft-decision) estimates for each symbol (or each bit).

Many alternative structures have been proposed to approach the ML detection performance. For example, the sphere de-coding algorithm (B. M. Hochwald and S. ten Brink, Achieving near-capacity on a multiple antenna channel, IEEE Trans. Commun., pages 389-399, 2003), approaches using the sequential Monte Carlo framework (B. Dong et al., A new class of soft MIMO demodulation algorithms. IEEE Trans. Signal Processing, pages 2752-63, 2003.) and methods based on semidefinite relaxation (A. Wiesel, 2005) have successfully been implemented. Although the detection schemes listed above have largely decreased the computational complexity, they are still exponential is the average case (sphere decoding (A. Wiesel et. al., 2007)) or high-degree polynomial (semidefinite relaxation). Neither of these approaches is practical for real-world hardware architecture applications. Thus, there is still a need for low complexity detection algorithms that can achieve good performance.

In accordance with embodiments of the present invention, a good detection performance may be achieved by using the belief propagation (BP) paradigm. It is well known (See e.g. (O. Shental et al., A message passing solver for linear systems, Information Theory and Applications (ITA) Workshop, pages 225-229, 2008)) that the BP algorithm has very poor convergence when applied to the MIMO detection problem since there are a large number of short cycles. In the experiment section presented below, it is shown again that this is indeed the case. There have been several recent successful attempts to apply BP to the MIMO detection problem with good results (e.g. (J. Hu and T. M. Duman, Graph-based detector for BLAST architecture, IEEE Communications Society ICC 2007, 2007), (M. Kaynak et al., Belief propagation over SISO/MIMO frequency selective fading channels, IEEE Transactions on Wireless Communications, pages 2001-5, 2007)). However in the methods proposed in J. Hu et al. and M. Kaynak et al., the factorization of the probability function is done in such a way that each factor corresponds to a single linear equation. This leads to a partition of the probability function into factors that are each a function of all the unknown variables. This leads to exponential computational complexity in computing the BP messages. Shental et al. analyzed the case where the channel matrix H is relatively sparse. They showed that even under this restricted assumption the BP still does not perform well. As an alternative method they proposed the generalized belief propagation (GBP) algorithm that does works well on the sparse matrix if the algorithm regions are carefully chosen. There are situations where the sparsity assumption makes sense (e.g. 2D intersymbol interference (ISI) channels). However, in the MIMO channel model it is assumed that the channel matrix elements are iid and Gaussian hence it can not be assumed that the channel matrix is sparse.

Below disclosed a novel method to obtain a BP based algorithm that is both efficient and provides improved detection performance by overcoming some of the above caveats.

The Pseudo-Prior-Belief-Propagation detector: Recall that in the linear system (1), the probability function of the discrete random vector x is:

$$P ( x ) = P ( {x}_{1} , … , {x}_{n} ) ∝ exp ( - \frac{1}{2 {σ}^{2}} {‖ Hx - y ‖}^{2} ) , x ∈ {A}^{n} \qquad ( 5 )$$

It can be easily verified that p(x) is factorized into a product of two- and single-variable potentials:

$$P ( {x}_{1} , … , {x}_{n} ) ∝ {\prod }_{i}^{ } {ψ}_{i} ( {x}_{i} ) {\prod }_{i \neq j}^{ } {ψ}_{ij} ( {x}_{i} , {x}_{j} ) \qquad ( 6 )$$

such that

$${ψ}_{i} ( {x}_{i} ) = exp ( - \frac{1}{2 {σ}^{2}} {y}^{⊤} {H}_{i} {x}_{i} ) \\ {ψ}_{ij} ( {x}_{i} , {x}_{j} ) = exp ( - \frac{1}{{σ}^{2}} {H}_{i}^{⊤} {H}_{j} {x}_{i} {x}_{j} ) \qquad ( 7 )$$

where Hᵢ is the i-th column of the matrix H. Since the obtained factors are just a function of pairs, the BP algorithm is most simply presented as a message passing scheme between the n variables. This is the Markov-Random-Field (MRF) variant of the BP algorithm (J. S. Yedidia et al., Understanding belief propagation and its generalizations, IJCAI, 2001). In the case of the present invention the MRF is an undirected graph with n vertices labeled by 1, . . . , n. The pairwise potential ψᵢⱼ(xᵢ,xⱼ) corresponds to the edge connecting node i and node j and the ψᵢ(xᵢ) corresponds to the vertex i. Since the matrix H is randomly selected, the MRF graph is usually a completely connected graph.

Below is reviewed the belief-propagation (also known as sum-product) algorithm applied to MRFs (for an elaborate presentation see J. S. Yedidia et al., 2001). The belief propagation algorithm propagates information throughout a graphical model via a series of messages sent between neighboring nodes. The BP message from xⱼ to xᵢ is:

$${m}_{j \to i} ( {x}_{i} ) = {\sum }_{{x}_{j} ∈ A}^{ } ( {ψ}_{j} ( {x}_{j} ) {ψ}_{ij} ( {x}_{i} , {x}_{j} ) {\prod }_{k \neq i , j}^{ } {m}_{k \to j} ( {x}_{j} ) ) \qquad ( 8 )$$

In each iteration messages are passed along the graph edges in both edge directions. In any iteration, an estimate of the posterior marginal distribution ('belief) for each variable can be computed by multiplying together all of the incoming messages from all the other nodes:

$${b}_{i} ( {x}_{i} ) = {ψ}_{i} ( {x}_{i} ) {\prod }_{k \neq i}^{ } {m}_{k \to i} ( {x}_{i} ) \qquad ( 9 )$$

In the final step the decoded symbol vector is:

$${\hat{x}}_{i} = arg {max}_{{x}_{i} ∈ A} {b}_{i} ( {x}_{i} ) , i = 1 , … , n \qquad ( 10 )$$

A variant of the sum-product algorithm is the max-product algorithm in which the summation in equation (8) is replaced by a maximization over all the constellation symbols. In a loop-free MRF graph the sum-product algorithm always converges to the exact marginal probabilities (which cor-responds in the case of MIMO detection to the posterior probability of each symbol p(xᵢ|y)). In a loop-free MRF graph the max-product message update rule finds the most likely pattern (which corresponds to ML decoding in our case). For loop-free graphs, BP is essentially a distributed variant of dynamic programming. The BP message update equations only involve passing messages between neighboring nodes. Computationally, it is thus straightforward to apply these same local message updates in graphs with cycles.

In most such models, however, this loopy BP algorithm will not compute exact marginal distributions; hence, there is almost no theoretical justification for applying the BP algorithm (one exception is that, for Gaussian graphs, if BP converges, then the means are correct (Y. Weiss and W. T. Freeman, Correctness of belief propagation in gaussian graphical models of arbitrary topology, Neural Computation, pages 2173-2200, 2001)). However, the BP algorithm applied to loopy graphs, has been found to have outstanding empirical success in many applications, e.g., in decoding Turbo (Y. Weiss, 1993) and LDPC codes (R. G. Gallager, 1962). The performance of BP in these applications may be attributed to the sparsity of the graphs. The cycles in the graph are long, hence inference may be performed as though the graph was loop-free. When the graph is not sparse, loopy BP almost always fails to converge and therefore the associated detection performance is poor. Unlike the sparse graphs of LDPC codes, the graphs of MIMO channels consist of many short cycles due to the high density connections in the completely connected graph. This has prevented the BP from being an asset for the MIMO problem.

We now present a modification that makes the BP a valuable method for MIMO detection in BPSK (±1) and 4-QAM (±1±i) constellations. To assist the BP algorithm concentrating on the right target, it is suggested to combine the result in the MMSE detector (4) in the BP iterations as a pseudo prior. Ignoring the finite-set constraints on the input, the MIMO system may be solved as a standard linear system. As such, not just the unbiased estimator can be obtained: \hat{x}=(H^{τ}H+φ²I)⁻¹H^{τ}_{y} but also its covariance matrix which is Var(\hat{x})=φ²(H^{τ}H+φ²I)⁻¹. The last step of the MMSE detector is performing hard decision on each component of \hat{x}. By also using the variance information Var(\hat{x}) we can compute the posterior probability of each symbol (soft-decision) as follows:

$${p}_{mmse} ( {x}_{i} \vert y ) ∝ exp ( - \frac{{( {x}_{i} - {x}_{i} )}^{2}}{2 {Var ( \hat{x} )}_{ii}} ) ∀ {x}_{i} ∈ A \qquad ( 11 )$$

where \hat{x}ᵢ is the un-constrained result obtained from the MMSE solution.

In the next step, the MMSE posterior information is integrated into the BP scheme as additional single-variable factors. The additional potentials are redundant and do not contribute any new information. This is a heuristic (like the loopy BP concept) and hence it should be experimentally justified. The additional potentials provided by the MMSE posterior probabilities can be viewed as a regularization term that prevents the BP from drifting away from the optimal solution. To control the influence of the prior, a weight to the additional factors can be added. The approach of the present invention, therefore, is based on applying the BP on the factors of the following modified probability function:

$${P}_{λ} ( x ) ∝ exp ( - \frac{1}{2 {σ}^{2}} {‖ Hx - y ‖}^{2} - λ {\sum }_{i}^{ } \frac{{( {x}_{i} - {\hat{x}}_{i} )}^{2}}{2 {Var ( \hat{x} )}_{ii}} ) = {\prod }_{i}^{ } {p}_{mmse}^{λ} ( {x}_{i} \vert y ) \qquad ( 12 )$$

The scalar parameter controls the relative importance of the redundant factors. If λ=0 the modified BP is reduced to the standard BP. When λ tends to infinity, the modified BP is reduced to the original MMSE solution. If the regularization prior is based on a real additional independent information then the correct value for the prior weight λ is 1. In the case of the present invention, it is a pseudo prior that is based on the same information obtained from the linear system. It was found empirically that the need for the pseudo prior increases monotonically with the SNR. For higher SNR, a larger λ is needed to obtain a good results. We have found that setting

$$λ = \frac{1}{{σ}^{2}}$$

works well for all SNR values.

The proposed method of the present invention is therefore a combination of two known MIMO detection methods, MMSE and BP. Each one of these methods has a poor detection performance. In the experiment presented below it is shown that combining these methods using weight

$$λ = \frac{1}{{σ}^{2}} ,$$

near maximum likelihood performance may be achieved.

Implementation issues: There are a few implementation issues regarding the pro-posed PPBP algorithm that require discussion. Even with the additional pseudo-prior the loopy BP does not always converge and it tends to oscillate between several points. To overcome this problem the hard-decision solution can be computed (using equation (10)) at the end of each BP iteration and after the BP converges, or after a pre-defined number of iterations, the solution that minimizes the exact cost function ∥Hx−y∥² can be chosen.

Applying the BP algorithm exactly as it is described above can lead to problems of numerical stability. To avoid this, the algorithm can work in the log domain. In this work the max-product (also known as belief revision) may be used, since it avoids complicated exponent-log computations and it can be carried out in the log domain using just addition operations which is useful for practical implementations.

The complexity of a straight-forward implementation of the BP algorithm is O(n³|A|) where A is the constellation set and n is the number of transmit antennas. The complexity is n³ because on each iteration we need to compute a message between each two variables and computing a single message is linear in n. The following efficient implementation (that is based on a certain scheduling of message passing) can reduce the BP complexity to be just a quadratic function of the number of transmit antennas:

$$for j = 1 , … , n$$

$${sum}_{j} ( {x}_{j} ) = {\sum }_{k \neq j}^{ } {m}_{k \to j} ( {x}_{j} )$$

$$for i = 1 , … , n$$

$${m}_{j \to i} ( {x}_{i} ) = {max}_{{x}_{j} ∈ A} ( {prior}_{j} ( {x}_{j} ) + {ϕ}_{j} ( {x}_{j} ) + {ϕ}_{ij} ( {x}_{i} , {x}_{j} ) + {sum}_{j} ( {x}_{j} ) - {m}_{i \to j} ( {x}_{j} ) )$$

$$where$$

$${ϕ}_{i} ( {x}_{i} ) = - \frac{1}{2 {σ}^{2}} {y}^{⊤} {H}_{i} {x}_{i}$$

$${ϕ}_{ij} ( {x}_{i} , {x}_{j} ) = - \frac{1}{{σ}^{2}} {H}_{i}^{⊤} {H}_{j} {x}_{i} {x}_{j}$$

and priorⱼ(xⱼ) is the weighted log posterior probability of the MMSE detector. In the next section it is shown that the PPBP performs better than the MMSE and even better than its sequential version MMSE-SIC. However, a significantly better decoder can be received by computing both the PPBP solution and the MMSE-SIC solution and taking the better one. The resulting combined detector works much better than its two components.

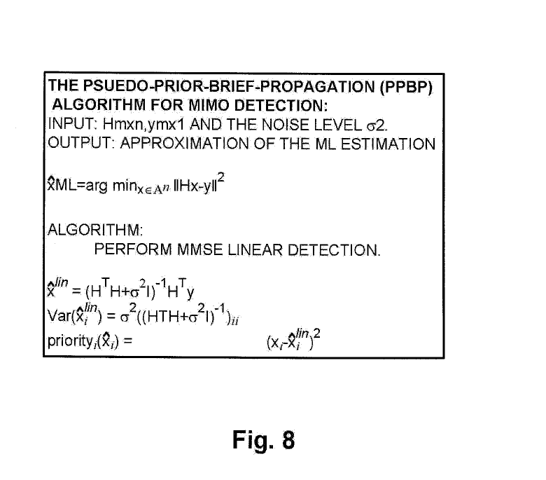

The proposed Pseudo-Prior-Belief-Propagation (PPBP) algorithm for MIMO detection is summarized (written in the log domain) in FIG. 8.

In accordance with embodiments of the present invention, the PPBP algorithm of the present invention may be implemented in a communication system having a program of machine-readable instructions for solving a detection problem according to a PPBP algorithm, tangibly embodied on a computer readable memory and executable by a digital data processor, to perform actions directed toward outputting a set of a-posteriori probability vectors, the actions including steps of:
a. receiving a tap gain matrix Hₘₓₙ;
b. performing a MMSE linear detection;
c. providing a max-product initialization m_{j->i}(xᵢ)=priorᵢ(xᵢ);
d. calculating the belief propagation for generating probabilities per symbol for each transmitted symbol, thereby providing beliefᵢ(xᵢ); and,
e. calculating the PPBP solution vector xᵢ by choosing the maximum a-posteriori probability among all alphabet symbols according to the equation: xᵢ=argmax_{xi∈A}beliefᵢ(xᵢ).

In accordance with embodiments, the communication system is a MIMO communication system.

Simulation results: In this section simulation results for the pro-posed PPBP detector over various uncoded. MIMO systems are provided. A quasi-static fading channel with a frame length of 100 is assumed. Under the assumption of block-fading channel model, the channel matrix H is constant for 100 channel uses. The channel matrix comprised iid elements drawn from a circularly symmetric zero-mean complex normal distribution of unit variance. 10,000 realizations of channel matrix are used. This results in 106 vector messages. The SNR is defined as 10 log₁₀(E_{b}/N₀) where E_{b} is the average received energy per symbol at each receiver antenna.

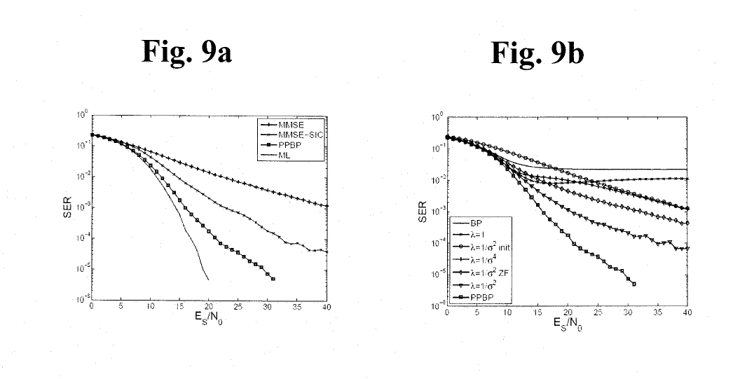

FIG. 9a shows the symbol error rate (SER) versus SNR for a 8×8 BPSK MIMO system. The performance of the proposed PPBP method is compared to ML detection and to other linear suboptimal algorithms: the linear MMSE and the sequential MMSE V-BLAST. In all the experiments the number of BP iterations was limited to 10 and the max-product variant described in FIG. 8 was used. According to this figure, it can be seen that the PPBP algorithm is significantly better than the MMSE-SIC at the same computational complexity.

FIG. 9b presents the performance of several variants of the BP algorithm. The BP variants are: the original BP, BP with three different weights of the pseudo-prior: λ=1, λ=1/φ², λ=1/φ⁴ Other variants are a standard BP where the pseudo-prior factors are simply used to initial the message at the first iteration and a BP with pseudo-prior weight of λ=1/φ² such that the pseudo-prior is based on zero-forcing instead of the MMSE estimator.

The last variant is the proposed PPBP which is based on a pseudo-prior with weight λ=1/φ², comparison the solution to MMSE-SIC and selection of the best one. As shown before, the BP yields very poor results for the MIMO detection problem. It is also shown that using the MMSE results solely for initializing the messages does not help and should be used as additional pseudo-prior factors. FIG. 9b also shows that taking λ=1/φ² is a preferred weight for the pseudo-prior factor.

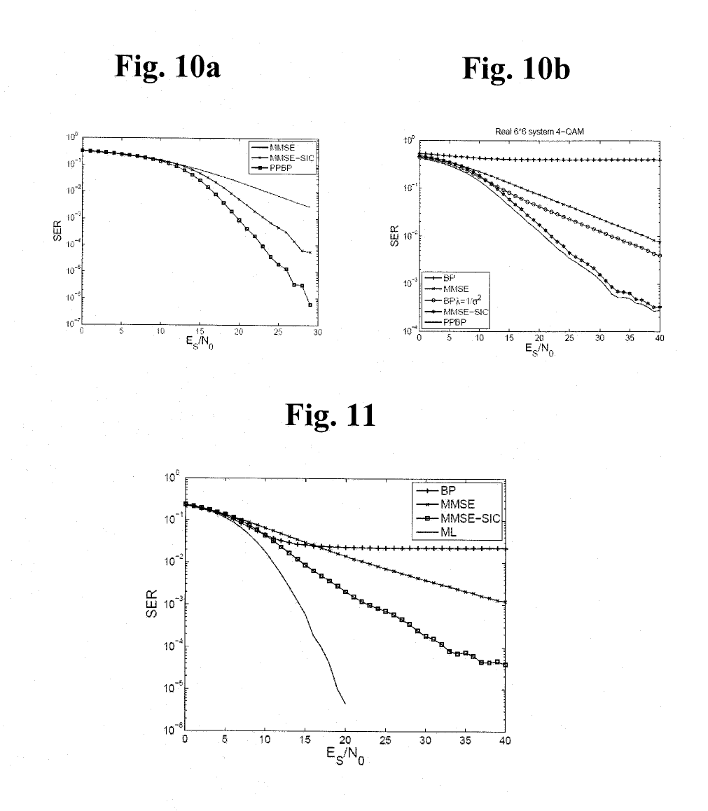

FIG. 10a depicts the improved performance results of the PPBP for the case 8×8 4-QAM complex MIMO system which is of course equivalent to 16 bits BPSK.

Extensions of the method: A. Combination with sphere decoding: While the method provides an excellent performance, it is interesting to mention that the fact that the method provides a-posteriori probabilities for each variable, applying a Schnorr-Euchner sphere decoding or any other version of the sphere decoding, ordering the symbols according to their a-posteriori probabilities can lead to very close to optimal performance in a significantly reduced complexity. The reason for that is that by computing the a-posteriori probabilities, we have much higher probability of finding the true solution within the first search, therefore significantly reducing the search radius.

B. Combination with forward error correction: The proposed system can be combined in a cascade or iteratively with a forward error correction like Turbo code or Low density parity check code. The probabilities per bit computed from the probability per symbol generated by the PPBP algorithm are fed as priors to the decoding of the forward error correction and initialize the decoding of the FEC. In this section we review several important applications of the proposed technique. We comment on combining it into communication systems with coding and interleaving. It is useful both for single carrier and OFDM systems. It can serve as a MIMO decoder for wireless communication systems and also in a DSL MIMO system. Using the a-posteriori probability distribution of the symbols we can easily compute the a-posteriori probability and the likelihood ratio for the bits. This is done using the following formulas:

$$P ( {b}_{i} = 0 ) = \frac{{\sum }_{s \text{:} {b}_{i} = 0}^{ } P ( S \vert X )}{{\sum }_{s}^{ } P ( S \vert X )} \\ P ( {b}_{i} = 1 ) = \frac{{\sum }_{tS \text{:} {b}_{i} = 1}^{ } P ( S \vert X )}{{\sum }_{s}^{ } P ( S \vert X )} \qquad ( 13 )$$

Using equation (13) we can pass to a forward error correction block log-likelihood ratios given by

$$L ( {b}_{i} ) = log \frac{{\sum }_{s \text{:} {b}_{i} = 0}^{ } P ( s \vert x )}{{\sum }_{s \text{:} {b}_{i} = 1}^{ } P ( s \vert x )} \qquad ( 14 )$$

Similarly one can simply compute the max-log-map ratio given by given by

$${L}_{max} ( {b}_{i} ) = log \frac{{max}_{s \text{:} {b}_{i} = 0} P ( s \vert x )}{{max}_{s \text{:} {b}_{i} = 1} P ( s \vert x )} \qquad ( 15 )$$

Note, however, that this is not so significant simplification in the case of the present invention, since in the present invention the a-posteriori distribution of symbols is computed first. The techniques can be combined into MIMO-OFDM system with bit interleaved coded modulation or with trellis coded modulation by joint coding of over all frequency tones of the OFDM system, and running the PPBP decoder for each tone. For single carrier systems the channel matrix can be a Toeplitz matrix. This has no effect on the applicability of the technique.

Application: The PPBP MIMO decoding system can be combined into many types of communication systems: Single carrier or OFDM, Coded system using various codes: Trellis coded modulation, Bit interleaved Coded modulation where the FEC is either convolution, Turbo code or low density parity check code. Finally an interesting application is to multi-cell cellular systems. Using the PPBP we can perform multi-cell equalization, so that other cell interference is completely removed. This is done by performing multi-user detection, using the algorithm, and the channel matrices between all the users and all the base stations of interest. These application can serve in DSL systems, Wireless communication systems such as WiMax or next generation 3GPP LTE, short range indoor wireless communication in the 60 GHz, Digital Terestrial and mobile TV receiver as well as in multi-antenna implementation of existing systems.

System description: A system implementing the new PPBP MIMO decoder is disclosed below. In this system, a receiver for a MIMO system which utilizes the PPBP to decode the received data in a computationally efficient manner is disclosed.

In accordance with embodiments, the Pseudo Prior Belief Propagation unit is adapted to receive as input parameters: A measured vector x, a channel matrix H, and a constellation α₁, . . . , α_{M}. Next, Pseudo prior computation unit is applied, and finally the Likelihood factoring unit perform calculations.

In accordance with embodiments of the present invention, the Pseudo Prior Belief Propagation unit may be implemented in the MIMO system illustrated in FIG. 3.

It is another object of the present invention to provide an algorithm for the linear least squares problem where the unknown variables are constrained to be in a finite set. The factor graph that corresponds to this problem is very loopy; in fact, it is a complete graph. Hence, applying the Belief Propagation (BP) algorithm yields very poor results. The algorithm of the present invention is based on an optimal tree approximation of the Gaussian density of the unconstrained linear system. Even though the approximation is not directly applied to the exact discrete distribution, applying the BP algorithm to the modified factor graph outperforms current methods in terms of both performance and complexity. The improved performance of the proposed algorithm is demonstrated on the problem of MIMO detection.

In accordance with embodiments, the method of the present invention is general and can be applied to any integer linear least-square problem. A multiple-input-multiple-output (MIMO) is one example of a communication system in which the algorithm of the present invention may be applied. The MIMO system is a communication system with n transmit antennas and m receive antennas. The tap gain from transmit antenna i to receive antenna j is denoted by Hᵢⱼ. In each use of the MIMO channel a vector x=(x₁, . . . , xₙ)^{τ} independently selected from a finite set of points A according to the data to be transmitted, so that x∈Aⁿ. A standard example of a finite set A in MIMO communication is A={−1,1} or more generally A={±1,±3, . . . , ±(2k+1)}. The received vector y is given by:

y=Hx+∉ (1)

The vector ∈ is an additive noise in which the noise components are assumed to be zero mean, statistically independent Gaussians with a known variance φ²I. The m×n matrix H is assumed to be known. (In the MIMO application we further assume that H comprises iid elements drawn from a normal distribution of unit variance.) The MIMO detection problem consists of finding the unknown transmitted vector x given H and y. The task, therefore, boils down to solving a linear system in which the unknowns are constrained to a discrete finite set. Since the noise is ∈ assumed to be additive Gaussian, the optimal maximum likelihood (ML) solution is:

$$\hat{x} = arg {min}_{x ∈ {A}^{n}} {‖ Hx - y ‖}^{2} \qquad ( 2 )$$

However, going over all the |A|ⁿ vectors is unfeasible when either n or |A| are large. A simple sub-optimal solution is based on a linear decision that ignores the finite set constraint:

z=(H^{τ}H)⁻¹H^{τ}y (3)

and then, neglecting the correlation between the symbols, finding the closest point in A for each symbol independently:

$${\hat{x}}_{i} = arg {min}_{a ∈ A} ‖ {z}_{i} - a ‖ \qquad ( 4 )$$

This scheme performs poorly due to its inability to handle ill-conditioned realizations of the matrix H. Somewhat better performance can be obtained by using a minimum mean square error (MMSE) Bayesian estimation on the continuous linear system. Let e be the variance of a uniform distribution over the members of A. We can partially incorporate the information that x∈Aⁿ by using the prior Gaussian distribution x˜N(0,eI). The MMSE estimation becomes:

$$E ( x \vert y ) = {( {H}^{⊤} H + \frac{{σ}^{2}}{e} I )}^{- 1} {H}_{y}^{⊤} \qquad ( 5 )$$

and then the finite-set solution is obtained by finding the closest lattice point in each component independently. A vast improvement over the linear approaches described above can be achieved by using sequential decoding:
a. Apply MMSE (5) and choose the most reliable symbol, i.e. the symbol that corresponds to the column with the minimal norm of the matrix:

$${( {H}^{⊤} H + \frac{{σ}^{2}}{e} I )}^{- 1} {H}^{⊤}$$

b. Make a discrete symbol decision for the most reliable symbol \hat{x}ᵢ. Eliminate the detected symbol: Σ_{j≠i}hⱼxⱼ=y−hᵢ\hat{x}ᵢ (hⱼ is the j-th column of H) to obtain a new smaller linear system. Go to the first step to detect the next symbol.

This algorithm, known as MMSE-SIC (G. J. Foschini, 1996), has the best performance for this family of linear-based algorithms but the price is higher complexity. These linear type algorithms can also easily provide probabilistic (soft-decision) estimates for each symbol. However, there is still a significant gap between the detection performance of the MMSE-SIC algorithm and the performance of the optimal ML detector.

Many alternative structures have been proposed to approach ML detection performance. For example, sphere decoding algorithm (an efficient way to go over all the possible solutions) (B. M. Hochwald and S. ten Brink, Achieving near-capacity on a multiple antenna channel, IEEE Trans. Commun., pages 389-399, 2003), approaches using the sequential Monte Carlo framework (B. Dong. et al., 2003) and methods based on semidefinite relaxation (A. Weisel et. al., 2005) have been implemented. Although the detection schemes listed above reduce computational complexity compared to the exhaustive search of ML solution, sphere decoding is still exponential in the average case (J. Jalden et al., 2004) and the semidefinite relaxation is a high-degree polynomial. Thus, there is still a need for low complexity detection algorithms that can achieve good performance.

The present invention provides a solution the integer least-squares problem using the Belief Propagation (BP) paradigm. It is well-known (see e.g. (O. Shental et al., 2008)) that a straightforward implementation of the BP algorithm to the MIMO detection problem yields very poor results since there are a large number of short cycles in the underlying factor graph.

In accordance with embodiments of the present invention, a novel approach to utilize the BP paradigm for MIMO detection is provided. The proposed variant of the BP algorithm is both computationally efficient and achieves near optimal results.

The Loopy Belief Propagation Approach: Given the constrained linear system y=Hx+∈, and a uniform prior distribution on x, the posterior probability function of the discrete random vector x given y is:

$$p ( x \vert y ) ∝ exp ( - \frac{1}{2 {σ}^{2}} {‖ Hx - y ‖}^{2} ) , x ∈ {A}^{n} \qquad ( 6 )$$

The notation x stands for equality up to a normalization constant. Observing that ∥Hx−y∥² is a quadratic expression, it can be easily verified that p(x|y) is factorized into a product of two- and single-variable potentials:

$$p ( {x}_{1} , … , {x}_{n} \vert y ) ∝ {\prod }_{i}^{ } {ψ}_{i} ( {x}_{i} ) {\prod }_{i < j}^{ } {ψ}_{ij} ( {x}_{i} , {x}_{j} ) \qquad ( 7 )$$

such that

$${ψ}_{i} ( {x}_{i} ) = exp ( - \frac{1}{2 {σ}^{2}} {y}^{⊤} {h}_{i} {x}_{i} ) , \\ {ψ}_{ij} ( {x}_{i} , {x}_{j} ) = exp ( - \frac{1}{{σ}^{2}} {h}_{i}^{⊤} {h}_{j} {x}_{i} {x}_{j} ) \qquad ( 8 )$$

where hᵢ is the i-th column of the matrix H. Since the obtained factors are simply a function of pairs, we obtain a Markov Random Field (MRF) representation (J. S. Yedidia et al., 2001). In the MIMO application the (known) matrix H is randomly selected and therefore, the MRF graph is usually a completely connected graph.

In a loop-free MRF graph the max-product variant of the BP algorithm always converges to the most likely configuration (which corresponds to ML decoding in our case). For loop-free graphs, BP is essentially a distributed variant of dynamic programming. The BP message update equations only involve passing messages between neighboring nodes. Computationally, it is thus straight forward to apply the same local message updates in graphs with cycles. In most such models, however, this loopy BP algorithm will not compute exact marginal distributions; hence, there is almost no theoretical justification for applying the BP algorithm. (One exception is that, for Gaussian graphs, if BP converges, then the means are correct (Y. Weiss et al., 2001)). However, the BP algorithm applied to loopy graphs has been found to have outstanding empirical success in many applications, e.g., in decoding LDPC codes (R. G. Gallager, 1962). The performance of BP in this application may be attributed to the sparsity of the graphs. The cycles in the graph are long, hence the graph have tree-like properties, so that messages are approximately independent and inference may be performed as though the graph was loop-free.

The BP algorithm has also been used successfully in image processing and computer vision, such as, fopr example, in (P. F. Felzenszwalb and D. P. Huttenlocher, Efficient belief propagation for early vision, International Journal of Computer Vision, pp. 41-54, 2006, where the image is represented using a grid-structured MRF that is based on local connections between neighboring nodes.

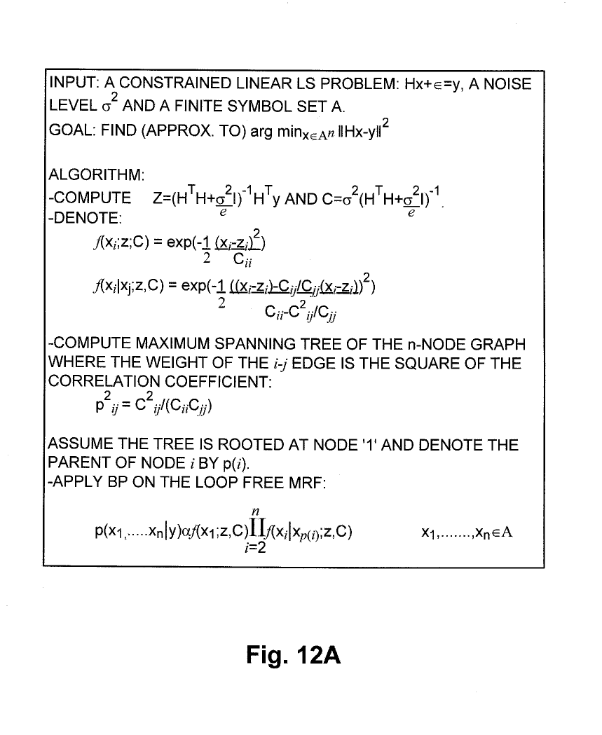

However, when the graph is not sparse, and is not based on local grid connections, loopy BP almost always fails to converge. Unlike the sparse graphs of LDPC codes, or grid graphs in computer vision applications, the MRF graphs of MIMO channels are completely connected graphs and therefore the associated detection performance is poor. This has prevented the BP from being an asset for the MIMO problem. FIG. 11 shows an example of a MIMO real-valued system based on an 8×8 matrix and A={−1, 1} (see the experiment section below for a detailed description of the simulation set-up). As can be seen in FIG. 11, the BP decoder based on the MRF representation (7) has very poor results. Standard techniques to stabilize the BP iterations such as damping the message updates do not help here. Even applying more advanced versions of BP (e.g. Generalized BP and Expectation Propagation) to inference problems on complete MRF graphs yields poor results (T. Minka and Y. Qi, Tree-structured approximations by expectation propagation, Advances in Neural Information Processing Systems, 2004). The problem here is not in the optimization method but in the cost function that needs to be modified yield a good approximate solution.

There have been several attempts to apply BP to the MIMO detection problem with good results, for example, J. Hu et al., 2007 and M. Kaynak et al., 2007. In the methods proposed in these references, however, the factorization of the probability function is done in such a way that each factor corresponds to a single linear equation.

This leads to a partition of the probability function into factors each of which is a function of all the unknown variables. This leads to exponential computational complexity in computing the BP messages. Shental et al. analyzed the case where the matrix H is relatively sparse (and has a grid structure). They showed that even under this restricted assumption the BP still does not perform well. As an alternative method they proposed the generalized belief propagation (GBP) algorithm that does work well on the sparse matrix if the algorithm regions are carefully chosen.

There are situations where the sparsity assumption makes sense (e.g. 2D intersymbol interference (ISI) channels). However, in the MIMO channel model we assume that the channel matrix elements are iid and Gaussian; hence we cannot assume that the channel matrix H is sparse.

The Tree Approximation of the Gaussian Density: The approach of this embodiment of the present invention is based on an approximation of the exact probability function:

$$p ( {x}_{1} , … , {x}_{n} \vert y ) ∝ exp ( - \frac{1}{2 {σ}^{2}} {‖ Hx - y ‖}^{2} ) , x ∈ {A}^{n} \qquad ( 9 )$$

that enables a successful implementation of the Belief Propagation paradigm. Since the BP algorithm is optimal on loop-free factor graphs (trees) a reasonable approach is finding an optimal tree approximation of the exact distribution (9).

C. K. Chow and C. N. Liu. Approximating discrete probability distributions with dependence trees, IEEE Trans. on Info. Theory, pp. 462-467, (1968) proposed a method to find a tree approximation of a given distribution that has the minimum Kullback-Leibler distance to the actual distribution. They showed that the optimal tree can be learned efficiently via a maximum spanning tree whose edge weights correspond to the mutual information between the two variables corresponding to the edges endpoints. The problem is that the Chow-Liu algorithm is based on the (2-dimensional) marginal distributions. However, finding the marginal distribution of the probability function (9) is, unfortunately, NP hard and it is (equivalent to) our final target.

To overcome this obstacle, the approach of the present invention is based on applying the Chow-Liu algorithm on the distribution corresponding to the unconstrained linear system. This distribution is Gaussian and therefore it is straightforward in this case to compute the (2-dimensional) marginal distributions. Given the Gaussian tree approximation, the next step of our approach is to apply the finite-set constraint and utilize the Gaussian tree distribution to form a discrete loop free approximation of p(x|y) which can be efficiently globally maximized using the BP algorithm. To motivate this approach a simplified version to derive the linear solution (4) described above is applied in the first step.

Let z(y)=(H^{τ}H)⁻¹H^{τ}_{y} be the least-squares estimator (3) and C=φ²(H^{τ}H)⁻¹ is its variance.

It can be easily verified that p(x|y) (9) can be written as:

$$p ( x \vert y ) ∝ f ( x ; z , C ) = exp ( - \frac{1}{2} {( z - x )}^{⊤} {C}^{- 1} ( z - x ) ) \qquad ( 10 )$$

where f(x; z, C) is a Gaussian density with mean z and covariance matrix C (to simplify notation the constant coefficient of the Gaussian densities is ignored hereafter). Now, instead of marginalizing the true distribution p(x|y), which is an NP hard problem, the approximation is performed by the product of the marginals of the Gaussian density f(x; z, C):

$$f ( x ; z , C ) \approx {\prod }_{i}^{ } f ( {x}_{i} ; {z}_{i} , {C}_{ii} ) = exp ( - \frac{{( {z}_{i} - {x}_{i} )}^{2}}{2 {C}_{ii}} ) \qquad ( 11 )$$

From the Gaussian approximation (11) we can extract a discrete approximation:

$$\hat{p} ( {x}_{i} = a \vert y ) ∝ f ( {x}_{i} ; {z}_{i} , {C}_{ii} ) = exp ( - \frac{{( {z}_{i} - a )}^{2}}{2 {C}_{ii}} ) , \\ a ∈ A \qquad ( 12 )$$

Taking the most likely symbol we obtain the sub-optimal linear solution (4).

Motivated by the simple product-of-marginals approximation described above, it is suggested in the present invention to approximate the discrete distribution p(x|y) via a tree-based approximation of the Gaussian distribution f(x; z, C). Although the Chow-Liu algorithm was originally stated for discrete distributions, one can easily verify that it also applies for the Gaussian case. Let

$$\begin{matrix}I ( {x}_{1} ; {x}_{j} ) = log {C}_{ii} + log {C}_{jj} - log \vert \begin{matrix}{C}_{ii} & {C}_{ij} \\ {C}_{ji} & {C}_{jj}\end{matrix} \vert \\ = - log ( 1 - {ρ}_{ij}^{2} )\end{matrix} \qquad$$

be the mutual information of x, and x, based on the Gaussian distribution f(x; z, C), where ρᵢⱼ, is the correlation coefficient between xᵢ and xⱼ. Let \hat{f}(x) be the optimal Chow-Liu tree approximation of f(x; z, C). It can be assumed, without loss of generality, that \hat{f}(x) is rooted at x₁. \hat{f}(x) is a loop-free Gaussian distribution on x₁, . . . , xₙ, i.e.

$$\hat{f} ( x ) = f ( {x}_{1} ; z , C ) {\prod }_{i = 2}^{n} f ( {x}_{i} \vert {x}_{p ( i )} ; z , C ) , \\ x ∈ {R}^{n} \qquad ( 13 )$$

where p(i) is the ‘parent’ of the i-th node in the optimal tree. The Chow-Liu algorithm guarantees that \hat{f}(x) is the optimal Gaussian tree approximation of f(x; z, C) in the sense that the KL divergence D(f∥\hat{f}) is minimal among all the Gauss-Markov distributions on Rⁿ. It is noted in passing that applying a monotonic function on the graph weights does not change the topology of the optimal tree. Hence to find the optimal tree the weights ρᵢⱼ² can be used instead of −log(1−ρᵢⱼ²). The optimal tree, therefore is one that maximizes the sum of the square correlation coefficients between adjacent nodes.

The approximation approach of the present invention is, therefore, based on replacing the true distribution p(x|y) with the following approximation:

$$\hat{p} ( {x}_{1} , … , {x}_{n} \vert y ) ∝ \hat{f} ( x ) = f ( {x}_{1} ; z , C ) {\prod }_{i = 2}^{n} f ( {x}_{i} \vert {x}_{p ( i )} ; z , C ) , \\ x ∈ {𝒜}^{n} \qquad ( 14 )$$

The probability function \hat{p}(x|y) is a loop free factor graph. Hence the BP algorithm can be applied to find its most likely configuration. An optimal BP schedule requires passing a message once for each direction of each edge. The BP messages are first sent from leaf variables to the root and then back to the leaves. We demonstrate empirically in the experiment section that the optimal solution of \hat{p}(x|y) is indeed nearly optimal for p(x|y).

The MMSE Bayesian approach (5) is known to be better than the linear based solution (4). In a similar way we can consider a Bayesian version of the proposed Gaussian tree approximation.

We can partially incorporate the information that x∈Aⁿ by using the prior Gaussian distribution x˜N(0,eI) such that

$$e = \frac{1}{\vert 𝒜 \vert} {\sum }_{a ∈ 𝒜}^{ } {a}^{2} .$$

This yields the posterior Gaussian distribution:

$${f}_{( x \vert y )} ( x \vert y ) ∝ exp ( - \frac{1}{2 e} {‖ x ‖}^{2} - \frac{1}{2 {σ}^{2}} {‖ Hx - y ‖}^{2} ) ∝ exp ( - \frac{1}{2} {( x - E ( x \vert y ) )}^{⊤} ( {H}^{⊤} H + \frac{{σ}^{2}}{e} I ) ( x - E ( x \vert y ) ) \qquad ( 15 )$$

Such that

$$E ( x \vert y ) = {( {H}^{⊤} H + \frac{{σ}^{2}}{e} I )}^{- 1} {H}^{⊤} y$$

We can apply the Chow-Liu tree approximation on the Gaussian distribution (15) to obtain a ‘Bayesian’ Gaussian tree approximation for p(x|y). One can expect that this yields is a better approximation of the discrete distribution p(x|y) than the tree distribution that is based on the unconstrained distribution f(x; z, C) since it partially includes the finite-set constraint. In the following section it is shown that the Bayesian version indeed yields better results.

In accordance with embodiments of the present invention, the present invention discloses a communication system having a program of machine-readable instructions for solving an ILS problem with a Belief Propagation (BP) paradigm, tangibly embodied on a computer readable memory and executable by a digital data processor, to perform actions directed toward outputting a set of a-posteriori probability vectors. The actions comprise steps of:
e. receiving a tap gain matrix Hₘₓₙ and a measured vector y;
f. applying a Chow-Liu algorithm on the distribution corresponding to the unconstrained linear system;
g. applying a finite-set constraint and utilizing the Gaussian tree distribution to form a discrete loop free approximation of p(x|y);
h. applying BP on the loop free Markov Random Field (MRF);

To summarize, the solution of the present invention to the constrained least squares problem is based on applying BP on a Gaussian tree approximation of the Bayesian version of the continuous least-square case. This method is called “The Gaussian-Tree-Approximation (GTA) Algorithm”. The GTA algorithm is summarized in FIG. 12. In the next step, the complexity of the GTA algorithm is computed. The complexity of computing the covariance matrix

$${( {H}^{⊤} H + \frac{{σ}^{2}}{e} I )}^{- 1}$$

is O(n³), the complexity of the Chow-Liu algorithm (based on Prim's algorithm for finding the minimum spanning tree) is O(n²) and the complexity of the BP algorithm is O(|A|²n).

Experimental Results: The simulation results for the GTA algorithm over various MIMO systems are provided below. It is assumed that a frame length of 100, i.e. the channel matrix H is constant for 100 channel uses. The channel matrix comprised iid elements drawn from a zero-mean normal distribution of unit variance. 10⁴ realizations of the channel matrix are used. This resulted in 10⁶ vector messages. The performance of the proposed algorithm is shown as a function of the variance of the additive noise φ². The signal-to-noise ratio (SNR) is defined as 10 log₁₀(Eₛ/N₀) where

$${E}_{s} / {N}_{0} = \frac{n e}{{σ}^{2}}$$

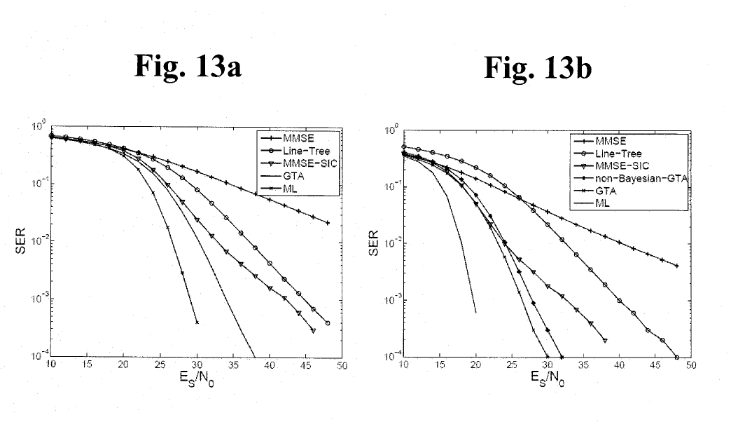

(n is the number of variables, φ² is the variance of the Gaussian additive noise, and e is the variance of the uniform distribution over the discrete set A). FIGS. 13a-b shows the symbol error rate (SER) versus SNR for a 10×10, |A|=8, MIMO system (FIG. 13a) and for a 20×20, |A|=4, MIMO system (FIG. 13b). It should be mentioned that the algorithm was applied in FIGS. 13a-b to a real world practical application (MIMO communication) using real world parameters. Unlike other areas (e.g computer vision, bioinformatics) here the real world performance analysis is based on extensive simulations of the communication channel. It is noted that a 20×20 fully connected MRF is not a small problem and unlike the Potts model that is defined on a grid MRF, the BP and it variants do not work here. The performance of the GTA method was compared to the MMSE and the MMSE-SIC algorithms. The GTA algorithm differs from these algorithms in two ways.

The first is a Markovian approximation of f(x; z, C) instead of a product of independent densities, and the second aspect is utilizing the optimal tree. To clarify the contribution of each component the GTA algorithm may be modified by replaced the Chow-Liu optimal tree by the tree 1→2→3, . . . , →n.

This method is called ‘Line-Tree’. As can be seen from FIGS. 13a-b, using the optimal tree is crucial to obtain improved results. FIG. 13b also shows results of the non-Bayesian variant of the GTA algorithm. As can be seen, the Bayesian version yields better results. In FIG. 12a the two versions yield the same results. It can be seen that the performance of the GTA algorithm is significantly better than the MMSE-SIC (and its computational complexity is much smaller).

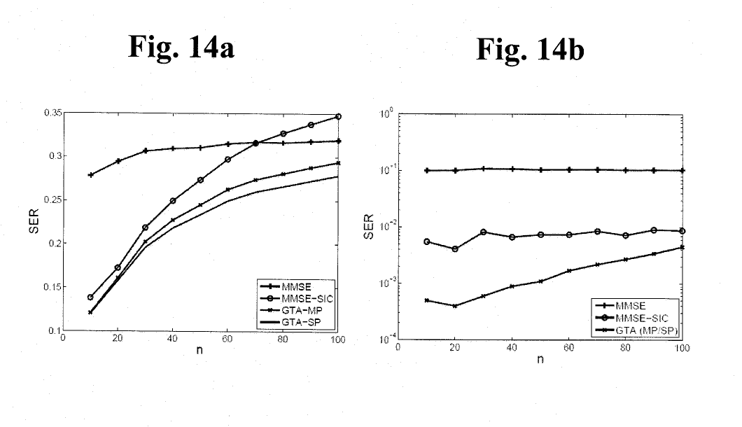

FIGS. 14a-b shows a comparative results of MMSE, MMSE-SIC and the GTA approximation followed by the sum-product and max-product variants of the BP algorithm. The alphabet size is |A|=8 and the results are shown as a function of the matrix size n×n.

FIGS. 14a-b depicts comparative performance results as a function of n, the size of the linear system. The alphabet size in all the experiments was |A|=8 and as in FIG. 13a each experiment was repeated 10⁴×10² times. The performance of the GTA method was compared to the MMSE and the MMSE-SIC algorithms. In FIG. 14a the noise variance was set to φ²=2.5 and in FIGS. 14b to φ2=0.25. In all cases the GTA was found to be better than the MMSE-SIC.

The GTA algorithm is based on an optimal Gaussian tree approximation followed by a BP algorithm. There are two variants of the BP, namely the max-product (MP) and the sum-product (SP). Since the performance is measured in symbol error-rate and not frame error-rate the SP should yield improved results. Note that if the exact distribution was loop-free then SP would obviously be the optimal method when the error is measured in number of symbols.

However, since the BP is applied to an approximated distribution the superiority of the SP is not straightforward. When the noise level is relatively high the sum-product version is better than the max-product. When the noise level is lower there is no significant difference between the two BP variants. Note that from an algorithmic point of view, the MP unlike the SP, can be easily computed in the log domain.

Solving integer linear least squares problems is an important issue in many fields. The present invention proposes a novel technique based on the principle of a tree approximation of the Gaussian distribution that corresponds to the continuous linear problem. The proposed method improved performance compared to all other polynomial algorithms for solving the problem as demonstrated in simulations. As far as it is know to the inventors, this is the first successful attempt to apply the BP paradigm to completely connected MRF. A main concept in the GTA model is the interplay between discrete and Gaussian models. Such hybrid ideas can be considered also for discrete inference problems other than least-squares. One example is the work of Opper and Winther who applied an iterative algorithm using a model which is seen as discrete and Gaussian in turn to address Ising model problems (M. Opper et. al., 2005). Although the focus of the present invention is on an approach based on tree approximation, more complicated approximations such as multi-parent trees have potential to improve performance and can potentially provide a smooth performance-complexity trade-off. Although the proposed method yields improved results, the tree approximation we applied may not be the best one (finding the best tree for the integer constrained linear problem is NP hard). It is left for future research to search for a better discrete tree approximation for the constrained linear least squares problem.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art

1. A communication system having a program of machine-readable instructions for solving an ILS problem, tangibly embodied on a computer readable memory and executable by a digital data processor, to perform actions directed toward outputting a set of a-posteriori probability vectors, the actions comprising steps of:
a. receiving an input vector x on a plurality of channels;
b. estimating a channel matrix H via a channel tracking unit;
c. computing matrices H_{m,n} by a projection generation unit;
d. projecting said input vector x onto a low-dimensional subspace via a vector projecting unit, said vector projecting unit;
e. computing the projections z₁, . . . , z_{d} via a one-dimensional unit;
f. computing a prior probability vectors for each coordinate of a solution vector s via a prior probability computation unit; and then
g. calculating said set of a-posteriori probability vectors for each coordinate by performing iterations with low-dimensional computations via a belief propagation unit.

2. The communication system of claim 1, wherein said low-dimensional subspace is a two-dimensional subspace.

3. The communication system of claim 1, wherein said final estimated vector is calculated by choosing the maximum a-posteriori probability among all the alphabet symbols.

4. The communication system of claim 1, wherein said prior probability vectors are calculated according to a solution technique selected from the group consisting of: a linear solution, L-MMSE, zero-forcing, V-BLAST, and any combination thereof.

5. The communication system of claim 1, wherein said the actions further comprise a step of sphere decoding said set of a-posteriori probability vectors.

6. The communication system of claim 1, wherein said actions are performed independently for each tone.

7. The communication system of claim 1, wherein said communication system is a MIMO communication system.

8. A method for solving an ILS problem in a MIMO communication system having a program of machine-readable instructions, tangibly embodied on a computer readable memory and executable by a digital data processor, comprising steps of:
a. receiving an input vector x on a plurality of channels;
b. estimating a channel matrix H via a channel tracking unit;
c. computing matrices H_{m,n} by a projection generation unit;
d. projecting said input vector x onto a low-dimensional subspace via a vector projecting unit, said vector projecting unit;
e. computing the projections z₁, . . . , z_{d} via a one-dimensional unit;
f. computing a prior probability vectors for each coordinate of a solution vector s via a prior probability computation unit; and then
g. calculating a set of a-posteriori probability vectors for each coordinate by performing iterations with low-dimensional computations via a belief propagation unit.

9. The method of claim 8, further comprising a step of providing said low-dimensional subspace in a two-dimensional subspace.

10. The method of claim 8, further comprising a step of calculating said final estimated vector by choosing the maximum a-posteriori probability among all the alphabet symbols.

11. The method of claim 8, further comprising a step of calculating said prior probability vectors according to a solution technique selected from the group consisting of: a linear solution, L-MMSE, zero-forcing, V-BLAST, and any combination thereof.

12. The method of claim 8, further comprising a step of sphere decoding said set of a-posteriori probability vectors.

13. The method of claim 8, further comprising a step of performing said actions independently for each tone.

14. The method of claim 8, further comprising a step of configuring said communication system as a MIMO communication system.

15. A communication system having a program of machine-readable instructions for solving a detection problem according to a PPBP algorithm, tangibly embodied on a computer readable memory and executable by a digital data processor, to perform actions directed toward outputting a set of a-posteriori probability vectors, the actions comprising steps of:
a. receiving a tap gain matrix Hₘₓₙ;
b. performing a MMSE linear detection;
c. providing a max-product initialization m_{j->i}(xᵢ)=priorᵢ(xᵢ);
d. calculating the belief propagation for generating probabilities per symbol for each transmitted symbol, thereby providing beliefᵢ(xᵢ); and,
e. calculating the PPBP solution vector xᵢ by choosing the maximum a-posteriori probability among all alphabet symbols according to the equation: xᵢ=argmax_{xi∈A}beliefᵢ(xᵢ).

16. The communication system of claim 15, further adapted to perform at least one action selected from a group consisting of: calculating the MMSE_SIC solution; comparing the performance of said MMSE_SIC solution to said PPBP solution; and selecting the preferred solution from said MMSE_SIC solution and said PPBP solution or any combination thereof.

17. The communication system of claim 15, wherein said actions further comprise a step of sphere decoding to prune the search according to a-posteriori symbol probabilities.

18. The communication system of claim 15, wherein said actions are performed independently for each tone.

19. The communication system of claim 15, wherein said actions are performed for the calculation of log-likelihood probabilities for each bit.

20. The communication system of claim 15, wherein said communication system is a MIMO communication system.

21. A method for solving a MIMO detection problem according to a PPBP algorithm in a MIMO communication system having a program of machine-readable instructions, tangibly embodied on a computer readable memory and executable by a digital data processor, comprising steps of:
a. receiving a tap gain matrix Hₘₓₙ and a measured vector y;
b. performing a MMSE linear detection;
c. providing a max-product initialization m_{j->i}(xᵢ)=priorᵢ(xᵢ);
d. calculating the belief propagation for generating probabilities per symbol for each transmitted symbol, thereby providing beliefᵢ(xᵢ); and then
e. calculating the PPBP solution vector xᵢ by choosing the maximum a-posteriori probability among all alphabet symbols according to the equation: xᵢ=argmax_{xi∈A}beliefᵢ(xᵢ).

22. The method of claim 21, further comprising a step of performing actions selected from a group consisting of: calculating the MMSE_SIC solution; comparing the performance of said MMSE_SIC solution to said PPBP solution; and selecting the preferred solution from said MMSE_SIC solution and said PPBP solution or any combination thereof.

23. The method of claim 21, further comprising a step of sphere decoding to prune the search according to a-posteriori symbol probabilities.

24. The method of claim 21, further comprising a step of performing said actions independently for each tone.

25. The method of claim 21, further comprising a step of performing said actions for the calculation of log-likelihood probabilities for each bit.

26. The method of claim 21, further comprising a step of providing said communication system as a MIMO communication system.

27. A communication system having a program of machine-readable instructions for solving an ILS problem with a Belief Propagation (BP) paradigm, tangibly embodied on a computer readable memory and executable by a digital data processor, to perform actions directed toward outputting a set of a-posteriori probability vectors, the actions comprising steps of:
a. receiving a tap gain matrix Hₘₓₙ and a measured vector y;
b. applying a Chow-Liu algorithm on the distribution corresponding to the unconstrained linear system;
c. applying a finite-set constraint and utilizing the Gaussian tree distribution to form a discrete loop free approximation of p(x|y); and then
d. applying BP on the loop free Markov Random Field (MRF).

28. The communication system of claim 27, wherein said actions further comprise a step of calculating:
$$z = {( {H}^{⊤} H + \frac{{σ}^{2}}{e} I )}^{- 1} {H}^{⊤} y and$$
$$C = {{σ}^{2} ( {H}^{⊤} H + \frac{{σ}^{2}}{e} I )}^{- 1}$$

29. The communication system of claim 27, wherein said step (d) applying BP on the loop free Markov Random Field (MRF) is performed on:
$$\hat{p} ( {x}_{1} , … , {x}_{n} \vert y ) ∝ f ( {x}_{1} ; z , C ) {\prod }_{i = 2}^{n} f ( {x}_{i} \vert {x}_{p ( i )} ; z , C ) .$$

30. The communication system of claim 27, wherein said communication system is a MIMO communication system.

31. A method for solving an ILS problem with a Belief Propagation (BP) paradigm in a MIMO communication system having a program of machine-readable instructions, tangibly embodied on a computer readable memory and executable by a digital data processor, comprising steps of:
a. receiving a tap gain matrix Hₘₓₙ and a measured vector y;
b. applying a Chow-Liu algorithm on the distribution corresponding to the unconstrained linear system;
c. applying a finite-set constraint and utilizing the Gaussian tree distribution to form a discrete loop free approximation of p(x|y); and then
d. applying BP on the loop free Markov Random Field (MRF).

32. The method according to claim 31, further comprising a step of calculating said actions according to a formula:
$$z = {( {H}^{⊤} H + \frac{{σ}^{2}}{e} I )}^{- 1} {H}^{⊤} y and$$
$$C = {{σ}^{2} ( {H}^{⊤} H + \frac{{σ}^{2}}{e} I )}^{- 1}$$

33. The method of claim 31, wherein said step (d) applying BP on the loop free Markov Random Field (MRF) is performed on:
$$\hat{p} ( {x}_{1} , … , {x}_{n} \vert y ) ∝ f ( {x}_{1} ; z , C ) {\prod }_{i = 2}^{n} f ( {x}_{i} \vert {x}_{p ( i )} ; z , C ) .$$

34. The method of claim 31, further comprising a step of providing said communication system as a MIMO communication system.
